(19) United States
(12) Patent Application Publication
(10) Pub. No.: US 2025/0208619 A1
(43) Pub. Date: Jun. 26, 2025

(54) METHODS AND SYSTEMS FOR REMOTE CONTROLLED VEHICLE

(71) Applicant: Rotor Technologies, Inc., Cambridge, MA (US)

(72) Inventors: Kristoffer FREY, Cambridge, MA (US); Yiou HE, Cambridge, MA (US); Gregor MCMILLAN, Cambridge, MA (US); Jacob Reinier MAAT, Cambridge, MA (US); David WALKER, Cambridge, MA (US); Haofeng XU, Cambridge, MA (US)

(21) Appl. No.: 17/969,052

(22) Filed: Oct. 19, 2022

Related U.S. Application Data
(60) Provisional application No. 63/257,898, filed on Oct. 20, 2021.

(51) Int. Cl. G05D 1/224; G05D 1/226; G05D 1/698; G05D 101/15; G05D 109/25; G08G 5/22

(52) U.S. Cl. CPC G05D 1/2247; G05D 1/226; G05D 1/6983; G08G 5/22; G05D 2101/15; G05D 2109/25

(57) ABSTRACT

The present invention provides a system for remote vehicle operation by human pilot and artificial intelligence systems. The system comprises: a vehicle capable of movement, a human operator and control station situated outside of the vehicle in a remote location, a bidirectional wireless communications channel, which transmits commands from the control station to the vehicle and which receives information related to the vehicle's state and its environment from the vehicle, and a human interface device conveying information to the human operator and receiving inputs.

### CROSS-REFERENCE TO RELATED APPLICATIONS

This application claims the priority and benefit of U.S. Provisional Application No. 63/257,898, filed on Oct. 20, 2021, the entirety of which is incorporated herein by reference.

### BACKGROUND

One conventional approach for controlling moving vehicles is through a pilot situated inside the vehicle; this conventional in-vehicle command and control approach may allow the pilot to provide direct control inputs to the vehicle such as through mechanical or hard-wired signal transmission schemes, to have direct visual and sensory feedback of the vehicle's state and its environment in real-time within an intuitive “first-person” (FP) experience, and to react and repair the vehicle in-situ and during operation. However, in-vehicle command and control has drawbacks. For example, the vehicle is required to make provision for the security and comfort of the human pilot, which in performance-constrained vehicles becomes a significant engineering burden, and the human pilot may be exposed to the environmental risk in which the vehicle operates. Further affordances for Pilot visibility and ergonomics create challenges and constraints.

Recently, an autonomous or remote approach for controlling vehicles without an in-vehicle human pilot has emerged. For example, control may be achieved by replacing the control and decision-making of the human pilot by computer instructions and/or artificial intelligence (“AI Mode”), or by providing the means for a human pilot situated outside of the vehicle to effectively control the vehicle using real-time or near real-time communications (“Human Mode”). In some cases, a combination of both methods may be used. For example, a system designed to operate autonomously in AI Mode during normal operations may rely on Human Mode for scenarios in which the AI Mode fails or requires higher-level guidance. In another example, in a primarily Human Mode system, automation in the lower levels of the control hierarchy may be used to improve mission performance (e.g., computerized precision trajectory following), to reduce pilot workload, or to tolerate communications delays and dropouts.

To achieve Human Mode operations, a real-time bidirectional wireless communications system is needed for two streams of information: (1) pilot inputs to control the vehicle need to be transferred from the pilot to the vehicle, and (2) information about the state of the vehicle and its environment needs to be transferred from the vehicle to the pilot. However, the effectiveness of Human Mode is significantly limited by the bandwidth, latency, and reliability of this communications channel. Additionally, existing human-machine interfaces may lack an intuitive user experience, further limiting the effectiveness of Human Mode. For example, the user interface may rely on fixed displays (e.g., a fixed dial or instrument) which are unable to adapt to the varying needs of the pilot as the mission or vehicle state changes. Even in the cases where the pilot can control the displayed content, it may be through cumbersome keyboard or joystick input (e.g., for panning an image), resulting in an unintuitive remote-piloting experience that falls significantly short of the intuitiveness of an in-vehicle experience, leading to reduced mission performance and safety compared to conventional in-vehicle piloting. For example, remotely piloted aircraft (RPA) such as the General Atomics MQ-1 Predator has a significantly worse operational safety record compared to conventionally piloted aircraft of similar size and mission type, predominantly attributed to the degraded situational awareness offered to the remote pilot through a low-bandwidth and high-latency communications channel.

### SUMMARY

A need exists for improved systems and methods of remote control of moving vehicles. Systems and methods of the present disclosure provide improved vehicle systems, communications links, and human-machine interfaces for this purpose. Systems and methods herein advantageously allow for individual operators (e.g., pilots) controlling vehicles by providing addition of digital controls and stability augmentation onboard the aircraft, the implementation of autonomous planning and piloting tools which improve safety or reduce pilot workload, and human machine interfaces which provide better situational awareness and control performance than a pilot located in the vehicle itself. In some embodiments, the human-machine interface system herein may comprise digital displays surrounding the pilot, showing real-time imagery from sensors onboard the vehicle. In some embodiments, the human-machine interface system may be wearable and the display may show computer-generated augmented reality or virtual reality imagery. Systems and methods of the present disclosure provide improved communication links and human-machine interface for remote control of movable objects (e.g., vehicles). In some embodiments, the human-machine interface system herein may be adaptive to passive pilot input. An example of the adaptation to passive pilot input is that the human-machine interface system may allow the information displayed to the pilot to change depending on measurements of the pilot's body position such as head and eye movement. In some embodiments, the human-machine interface system herein may comprise digital displays that are fixed to the control station, upon which real-time images may only be needed/displayed in the areas where the pilot's head is pointed thereby significantly reducing the requisite bandwidth of data. In other cases, a digital display may be fixed relative to the pilot's head and display images according to head movement, providing an immersive first-person view experience.

The systems and methods presented herein may provide the interconnectivity of a plurality of vehicles controlled by multiple pilots to share data, make decisions cooperatively, and to ensure a level of performance and safety that would be impossible using distributed decision-making. A pilot located in a single vehicle is limited by what is immediately observable from the perspective of the vehicle and except for explicit communications with other vehicles or with a centralized controller (e.g., an air traffic controller for aircraft), all decision-making by the pilot is necessarily distributed. In this present disclosure, the aggregation of pilots and information in a location separate from the vehicle itself and in a potentially centralized location (although centralization can occur virtually on a shared data server) provides a framework for collaborative information-sharing that is currently not possible and beneficially lead to improved safety, cost, and performance.

In an aspect, a system is provided for remote operation of a vehicle by human operator. The system comprises: a vehicle comprising a fly-by-wire control system for controlling an actuator of the vehicle in response to a command received from the human operator located at a control station; a bidirectional wireless communications system configured to transmit the command from the control station to the vehicle, and receive data related to the vehicle's state and an environment from the vehicle; and a human interface device located at the control station remote from the vehicle, where the human interface device is configured to display a live virtual view constructed based at least in part on image data received from the vehicle.

In a related yet separate aspect, a method is provided for remote operation of a vehicle by human operator. The method comprises: controlling, via a fly-by-wire control system, an actuator of the vehicle in response to a command received from the human operator located at a control station; providing a bidirectional wireless communications system to transmit the command from the control station to the vehicle, and receive data related to the vehicle's state and an environment from the vehicle; and displaying, via a human interface device located at the control station remote from the vehicle, a live virtual view constructed based at least in part on image data received from the vehicle.

In some embodiments, the vehicle is a helicopter. In some embodiments, the vehicle comprises one or more processors to process sensor data collected by sensors onboard the vehicle. In some cases, the sensor data is processed by a machine learning algorithm trained model.

In some embodiments, the bidirectional wireless communications system comprises a combination of a plurality of links including a satellites network communication link, a direct radio frequency communication link and a terrestrial wireless communication link. In some cases, the vehicle comprises a multiplexing gateway configured to duplicate critical telemetry data and broadcast over the plurality of links.

In some embodiments, the control station is stationary or mobile. In some embodiments, the live virtual view is adaptively displayed according to a measurement of a movement of the human operator's head and/or eyes. In some cases, the live virtual view is 720 degree.

In another aspect, a system is provided for remote operation of a plurality of vehicles by a network of human operators. The system comprises: each of the plurality of vehicles comprising a fly-by-wire control system for controlling an actuator of the respective vehicle in response to a respective command received from a control station that is remote from the plurality of vehicles; providing a bidirectional wireless communications system to transmit the command from the control station to the vehicle, and receive data related to the vehicle's state and an environment from the vehicle; and adaptively displaying, via a human interface device located at the control station remote from the vehicle, an information processed from the received data to the human operator according to a measurement of a movement of the human operator's head and/or eyes.

In a related yet separate aspect, a method is provided for remote operation of a plurality of vehicles by a network of human operators. The method comprises: controlling, via a fly-by-wire control system of a respective vehicle, an actuator of the respective vehicle in response to a command received from a control station that is remote from the plurality of vehicles; providing a bidirectional wireless communications system to transmit the command from the control station to the respective vehicle, and receive data related to the plurality of vehicles' state and an environment from the plurality of vehicles; and aggregating, by a computer system located at the control station, the data received from the plurality of vehicles and displaying information to the network of human operators via a plurality of human interface devices.

In some embodiments, the information is processed from data collected by complementary sensors located onboard different vehicles. In some embodiments, at least one human operator is selected from the network of human operators and dynamically assigned to operate a vehicle from the plurality of vehicles. In some embodiments, the command is generated using a machine learning algorithm trained model based on the data aggregated from the plurality of vehicles. In some cases, a command for controlling a first vehicle from the plurality of vehicles is generated based at least in part on a behavior of a second vehicle from the plurality of vehicles.

In some embodiments, at least one of the plurality of human interface devices is configured to display the information and receive input from an active user from the network of human operators for controlling a respective vehicle and at least one of the plurality of human interface devices is configured to only display the information to a passive user from the network of human operators.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure may be capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of a system for remote controlling a moving object.

FIG. 2 schematically illustrates the architecture of the system for remote controlling of an aircraft.

FIG. 3 and FIG. 4 illustrate examples of movable vehicles.

FIG. 5 shows examples of aircraft controlled by the methods and systems herein.

FIG. 6 and FIG. 7 show examples of the system architecture.

FIG. 8 schematically illustrates a user interface provided at the remote control station.

FIG. 9 schematically shows the functional structure for a system for remote controlling a vehicle.

FIG. 10 schematically illustrates the architecture of sub-systems located onboard a vehicle.

FIG. 11 schematically illustrates the architecture of a communications system between the vehicle and a mobile remote control station.

FIG. 12 schematically illustrates the architecture of a communications system between the vehicle and a stationary remote control station.

FIG. 13 schematically illustrates the architecture of a remote control station.

FIG. 14 shows a network of pilots and vehicles.

### DETAILED DESCRIPTION

The present disclosure provides systems and methods allowing for improved state- and situational-awareness (SSA) beyond the capabilities of conventional in-vehicle piloting. Systems and methods herein may present a Remote Pilot with the same visual and sensory information as that available in the vehicle. This may beneficially reduce disorientation stemming from physical detachment from the vehicle and enable safe, effective navigation and operation. The system may further improve a remote pilot's situational awareness by removing the spatial and visibility constraints of a physical internal vehicle cockpit, and by leveraging omni-directional cameras and onboard computer processing to provide immersive synthetic vision. Such improved remote control mechanism and methods may allow the vehicles to be used in challenging conditions and complex tasks, such as aerial firefighting, in particular at night or in smoky conditions.

In some embodiments, the system may comprise an on-board control mechanism by combining onboard sensors with fly-by-wire or other digital actuation of vehicle control surfaces, a robust communications channel, and an immersive simulated cockpit environment.

The onboard sensors may comprise one or more imaging devices (e.g., camera). The imaging devices may comprise one or more cameras configured to capture multiple image views at a same moment. For example, the one or more imaging devices may comprise a first imaging device and a second imaging device disposed at different locations onboard the vehicle relative to each other such that the first imaging device and the second imaging device have different optical axes. The imaging devices may capture different wavelengths of electromagnetic radiation (e.g. InfraRed, UltraViolet, etc).

Video streams from onboard cameras may be combined together allowing for an effective field of view greater than that afforded to a pilot inside a conventional vehicle. For instance, the video streams may be used to construct a 720 degree of solid angle (i.e., full omnidirectional) virtual view to an operator/pilot without obstruction. For instance, the operator/pilot may be able to see underneath the cockpit without obstruction.

In some cases, auxiliary information such as vehicle orientation or the presence of relevant hazards such as power lines and other aircraft may be overlaid to the real-time video streams via artificial horizons and other computer-generated graphics. Some of these overlays may highlight objects that are detected from the video data itself or from other sensors onboard the vehicle, some overlays may be generated from stored data (e.g., maps or terrain data) or data from external sources (e.g., an Automatic Dependent Surveillance-Broadcast system), and other overlays may be entirely artificially generated. In some cases, the entire digital pilot environment may be generated with computer graphics.

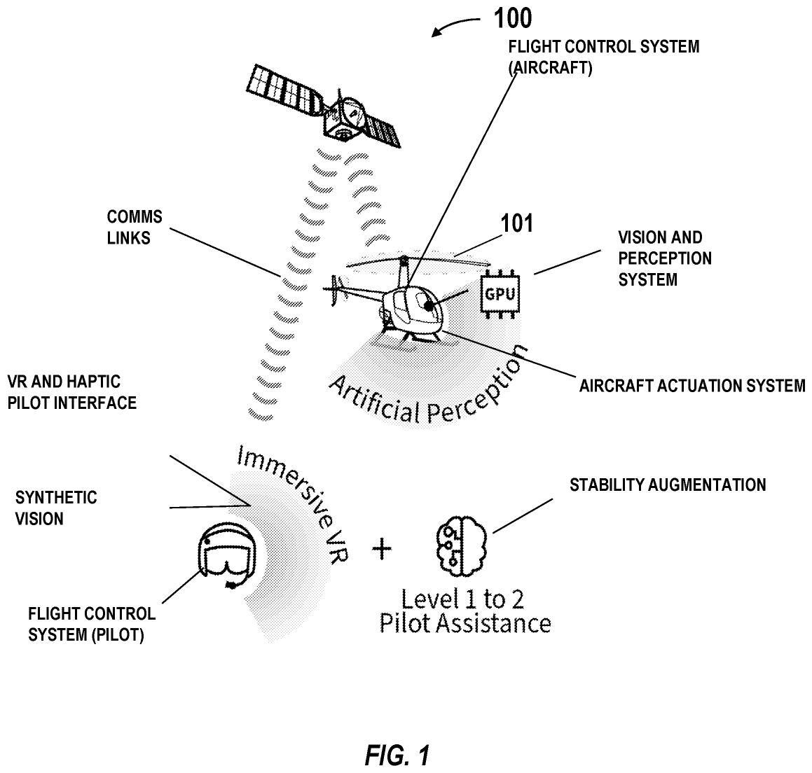

In some cases, systems and methods herein may provide a proprietary encoding algorithm such as applying a multi-view video coding format to the raw video data. The encoding algorithm may comprise correlating the raw video data obtained by the one or more imaging devices, and reducing information redundancy in the raw video data. The raw video data may be encoded by the one or more processors substantially in or near real-time as the raw video data is being captured by the one or more imaging devices. The system may comprise an encoder to process the video stream onboard. For instance, as shown in FIG. 1, imaging devices may transmit the raw image data to the encoder to be processed (encoded) into encoded video data. The encoder may be implemented by one or more onboard processors.

The video stream and telemetry data may be transmitted from the vehicle (e.g., aircraft) to a ground station and may be used to provide vestibular and haptic feedback. In some cases, the telemetry data may include the aircraft orientation, altitude, velocity, and/or accelerations, estimated forces and torques being applied by the environment against aircraft control surfaces. The vehicle telemetry data may be based on sensor data captured by one or more types of sensors. Some examples of types of sensors may include location sensors (e.g., global positioning system (GPS) sensors, mobile device transmitters enabling location triangulation), vision sensors (e.g., imaging devices capable of detecting visible, infrared, or ultraviolet light, such as cameras), proximity or range sensors (e.g., ultrasonic sensors, lidar, time-of-flight or depth cameras), inertial sensors (e.g., accelerometers, gyroscopes, and/or gravity detection sensors, which may form inertial measurement units (IMUs)), altitude sensors, attitude sensors (e.g., compasses), pressure sensors (e.g., barometers), temperature sensors, humidity sensors, vibration sensors, audio sensors (e.g., microphones), and/or field sensors (e.g., magnetometers, electromagnetic sensors, radio sensors) and various others.

In some embodiments, the video stream, along with relevant vehicle telemetry may be processed at the ground station and/or the onboard processors and presented to the remote pilot(s)/operator(s) via a display device. The display device may include a wearable device. For example, the display device may be configured to be worn by a user. In some cases, the display device may be a pair of glasses, goggles, or a head-mounted display. The display device may include any type of wearable computer or device incorporating augmented reality (AR) or virtual reality (VR) technology. AR and VR involve computer-generated graphical interfaces that provide new ways for users to experience content. In augmented reality (AR), a computer-generated graphical interface may be superimposed over real world video or images on a display device. In virtual reality (VR), a user may be immersed in a computer-generated environment rendered on a display device. The display device provided herein may be configured to display a first person view (FPV) of the real world environment from the movable object, in an AR setting or VR setting.

In some embodiments, the remote control station may comprise a simulated cockpit of the control station. Within the simulated cockpit of the control station, the vehicle telemetry data may be communicated to the pilots via the motion of their seats and resistances of the corresponding controls. In some cases, the remote control station may comprise a mobile pilot seat and/or a cockpit-style control. In some cases, vehicle telemetry including vehicle orientation and accelerations may be communicated through the mobile pilot seat that is capable of up to six-axis motion. In some cases, haptic feedback on “stick and rudder” cockpit-style controls may communicate forces and torques experienced by the vehicle in real time. Pilot commands specific to the target vehicle may be communicated via the cockpit-style controls and may be simultaneously transmitted back to the vehicle via the communications channel. The received pilot commands may be implemented on the control surfaces by an onboard fly-by-wire or other digital actuation system.

The video stream, along with relevant vehicle telemetry, may be communicated to the remote control station via a robust, low-latency communications channel. System herein may provide a reliable communications channel with sufficient bandwidth and minimal latency. Depending on the application and the physical distance between remote operator and aircraft, the channel may be a direct line-of-sight radio or other electromagnetic communications, or employ a more complex communications scheme reliant on a network of ground-, aircraft-, or satellite-based repeaters for the signal.

FIG. 1 shows an example of a system 100 for remote controlling a moving object 101. The movable object may be capable of moving freely within the environment with respect to six degrees of freedom (e.g., three degrees of freedom in translation and three degrees of freedom in rotation). Alternatively, the movement of the movable object can be constrained with respect to one or more degrees of freedom, such as by a predetermined path, track, or orientation. The movement can be actuated by any suitable actuation mechanism, such as an engine or a motor. The actuation mechanism of the movable object can be powered by any suitable energy source, such as chemical energy, electrical energy, magnetic energy, solar energy, wind energy, gravitational energy, nuclear energy, or any suitable combination thereof. The movable object may be self-propelled via a propulsion system, as described elsewhere herein. The propulsion system may optionally run on an energy source, such as electrical energy, magnetic energy, solar energy, wind energy, gravitational energy, chemical energy, nuclear energy, or any suitable combination thereof.

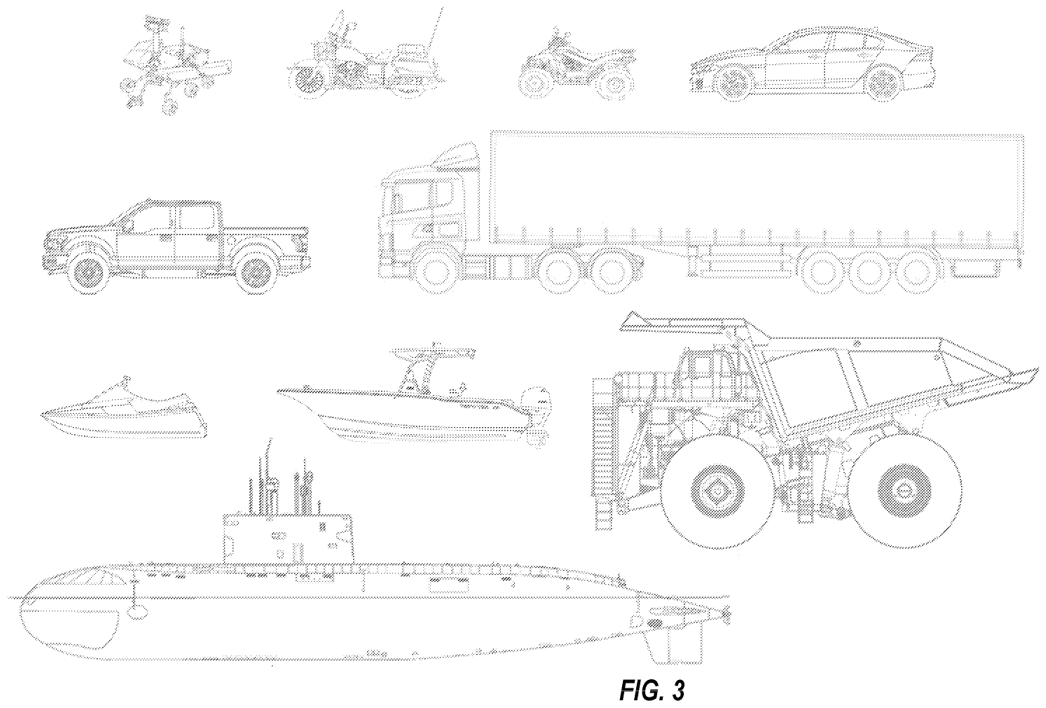

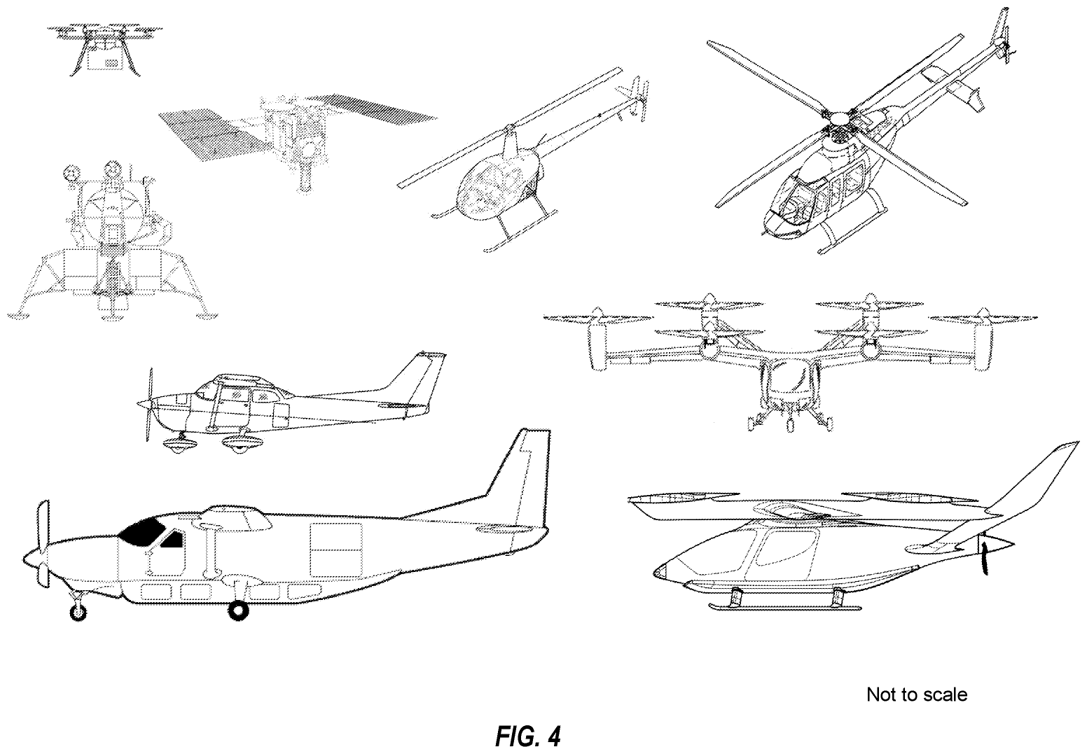

In some embodiments, the movable object can be a vehicle. FIG. 3 and FIG. 4 illustrate examples of movable vehicles. Suitable vehicles may include water vehicles, aerial vehicles, space vehicles, or ground vehicles.

Vehicle. The vehicle can move within a real-world environment, where there may be both static (e.g., the ground) and dynamic (e.g., other vehicles) objects. The vehicle may be able to move with respect to multiple degrees of freedom (e.g., three degrees of freedom in translation and three degrees of freedom in rotation) or it may be constrained with respect to one or more degrees of freedom, such as by a predetermined path, track, or orientation, or because it is an underactuated vehicle. For example, a train running on tracks has one primary degree of freedom (i.e., forward motion), an airplane typically has four degrees of freedom (i.e., pitch, roll, yaw, forward motion). The remote piloting systems described herein are appropriate and effective for many types of moving vehicle irrespective of its number of degrees of freedom, its propulsion mechanism, and its energy source.

Types of Vehicles. Suitable vehicles may include water vehicles, aerial vehicles, space vehicles, or ground vehicles. For example, aerial vehicles may be fixed-wing aircraft (e.g., airplane, gliders), rotary-wing aircraft (e.g., helicopters, rotorcraft), aircraft having both fixed wings and rotary wings, or aircraft having neither (e.g., blimps, hot air balloons). The vehicle can utilize a propulsion system, such as a propulsion system including one or more engines, motors, wheels, axles, magnets, rotors, propellers, blades, nozzles, or any suitable combination thereof. In some instances, the propulsion system can be used to enable the movable object to take off from a surface, land on a surface, maintain its current position and/or orientation (e.g., hover), change orientation, and/or change position.

Ground and Water Vehicles. In some embodiments, the vehicle may be a ground or water vehicle. FIG. 3 shows examples of ground and water vehicles that may be controlled by this invention.

Helicopter. In some embodiments, the vehicle may be a vertical takeoff and landing aircraft or helicopter. FIG. 4 shows examples of aircraft controlled by the methods and systems herein. In some cases, the aircraft may be powered by liquid hydrocarbon fuel or by hydrogen fuel. In some cases, the aircraft may comprise a single-single architecture or two-engine architecture. In some cases, the aircraft may comprise a swashplate-based rotor control system that translates input via the helicopter flight controls into motion of the main rotor blades. The swashplate may be used to transmit the pilot's commands from the non-rotating fuselage to the rotating rotor hub and main rotor blades.

Airplanes. In some embodiments, the vehicle may be an airplane. FIG. 4 shows examples of aircraft that may be controlled by this invention. In some cases, the aircraft may be powered by liquid hydrocarbon fuel, by hydrogen fuel, or by electric batteries. In some cases, the aircraft may comprise a single-single architecture or multi-engine architecture. In some cases, the aircraft may comprise elevators, rudders, canards, ailerons, flaps, and other moving aerodynamic control surfaces which support stability and control of the vehicle.

Electric Vertical Takeoff and Landing Aircraft. In some embodiments, the vehicle may be an electric vertical takeoff and landing aircraft or helicopter with distributed electric propulsion. The propellers and rotors may be controlled by digital control systems and propelled by electric motors. The vehicle may be able to takeoff and land vertically like a helicopter, where lift is provided by rotors, propellers, or jets, and transition to cruise like an airplane, where lift is provided by fixed wings.

Size of Vehicle. The vehicle can have any suitable size and/or dimensions. In some embodiments, the vehicle may be of a size and/or dimensions to have a human occupant within or on the vehicle. Alternatively, the vehicle may be of size and/or dimensions smaller than that capable of having a human occupant within or on the vehicle.

Other Vehicles. Although the vehicle is depicted as certain ground, water, and aerial vehicles, these depictions are not intended to be limiting, and any suitable type of movable object can be used, as previously described herein. One of skill in the art would appreciate that any of the embodiments described herein in the context of aircraft systems can be applied to any suitable movable object.

For example, as shown in FIG. 4, aerial vehicles may be fixed-wing aircraft (e.g., airplane, gliders), rotary-wing aircraft (e.g., helicopters, rotorcraft), aircraft having both fixed wings and rotary wings, or aircraft having neither (e.g., blimps, hot air balloons). A vehicle can be self-propelled, such as self-propelled through the air, on or in water, in space, or on or under the ground. A self-propelled vehicle can utilize a propulsion system, such as a propulsion system including one or more engines, motors, wheels, axles, magnets, rotors, propellers, blades, nozzles, or any suitable combination thereof. In some instances, the propulsion system can be used to enable the movable object to take off from a surface, land on a surface, maintain its current position and/or orientation (e.g., hover), change orientation, and/or change position.

The movable object can be controlled remotely by a user or controlled locally by an occupant within or on the movable object. The movable object can be controlled by a human or an autonomous control system (e.g., a computer control system), or any suitable combination thereof. The movable object can be an autonomous or semi-autonomous robot, such as a robot configured with an artificial intelligence.

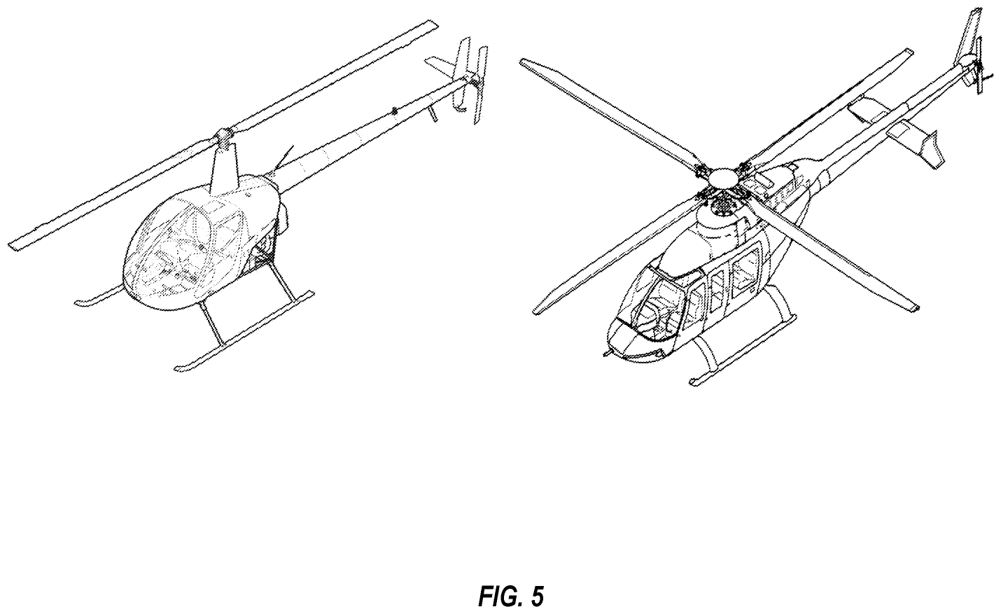

In some embodiments, the movable object may be a vertical takeoff and landing aircraft or helicopter. FIG. 5 shows examples of aircraft controlled by the methods and systems herein. In some cases, the aircraft may be powered by liquid hydrocarbon fuel. In some cases, the aircraft may comprise a single-single architecture or two-engine architecture. In some cases, the aircraft may comprise a swashplate-based rotor control system that translates input via the helicopter flight controls into motion of the main rotor blades. The swashplate may be used to transmit the pilot's commands from the non-rotating fuselage to the rotating rotor hub and main rotor blades.

Although the movable object is depicted as an aircraft, this depiction is not intended to be limiting, and any suitable type of movable object can be used, as previously described herein. One of skill in the art would appreciate that any of the embodiments described herein in the context of aircraft systems can be applied to any suitable movable object (e.g., a helicopter).

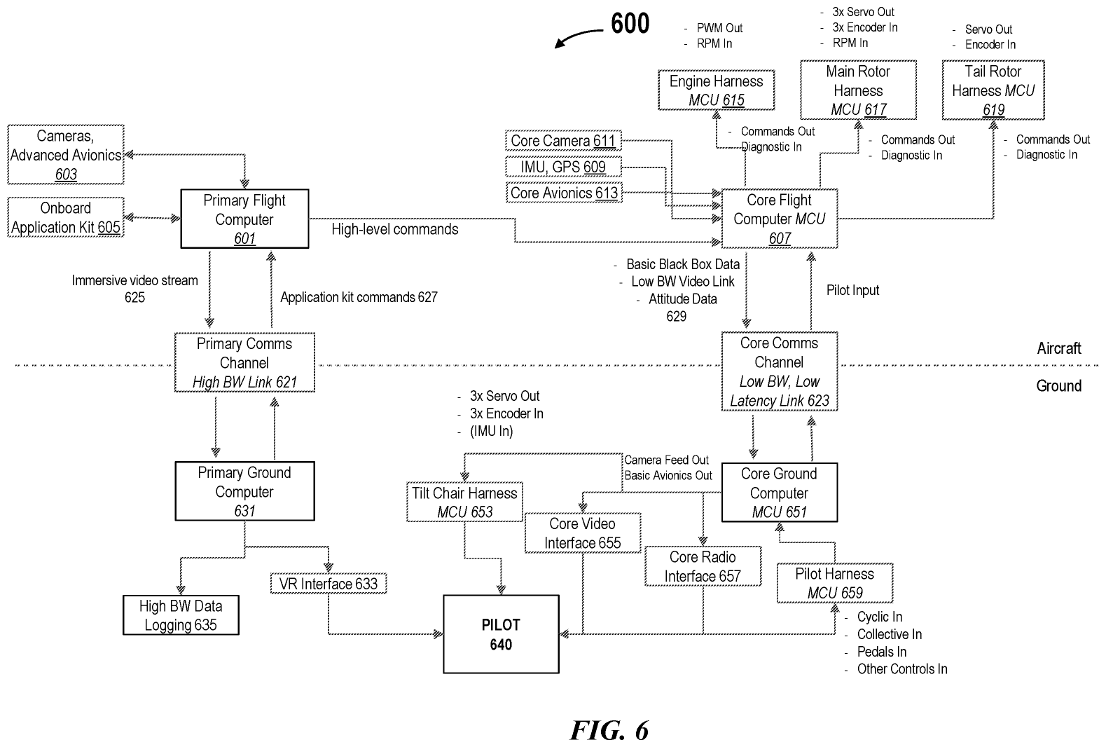

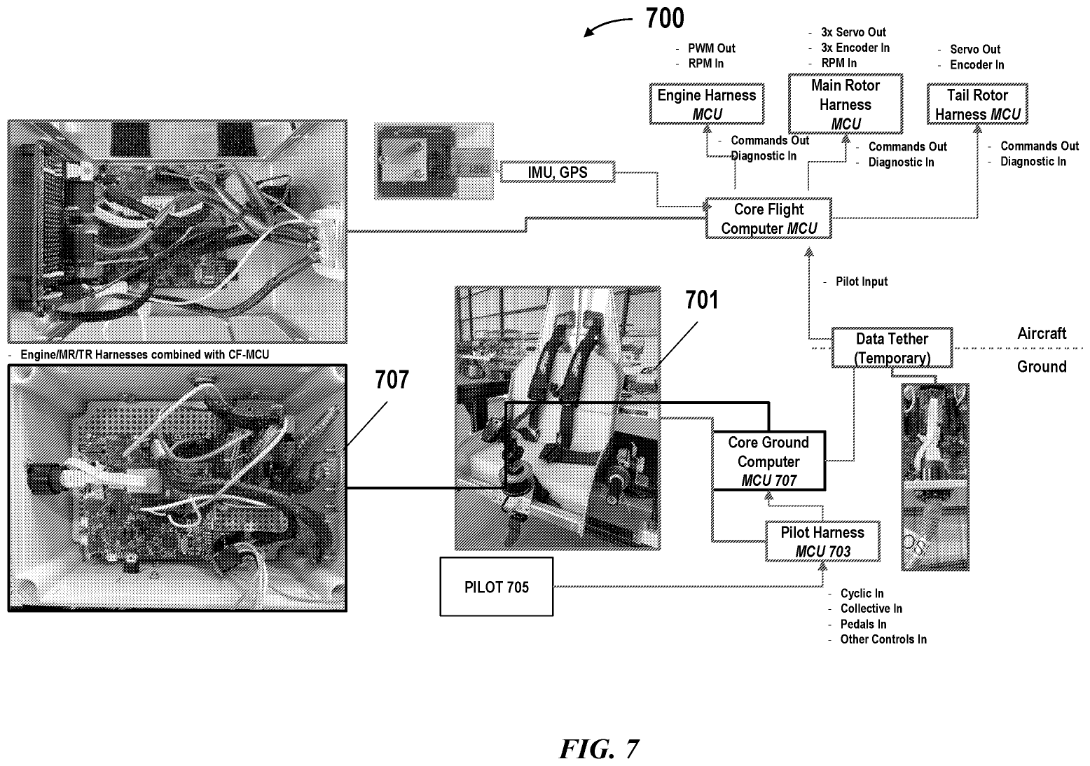

FIG. 6 and FIG. 7 show examples of the system architecture 600, 700. The movable object (e.g., aircraft) may comprise a primary flight computer 601 in communication with sensors (e.g., cameras, etc.), advanced avionics 603, and onboard application kit 605, a core flight computer (e.g., MCU) 607 that is in communication with a sensing system (e.g., IMU, GPS, etc.) 609, imaging devices 611, core avionics 613, propulsion mechanisms, and a communication system. For instance, the core flight computer 607 may send commands to the engine harness MCU 615, the main rotor harness MCU 617 or the tail rotor harness MCU 619 and/or receive diagnostic data from the above component of the propulsion mechanism.

In some embodiments, the propulsion mechanisms may comprise engine harness MCU 615, main rotor harness MCU 617, and a tail rotor harness MCU 619. The propulsion mechanisms can include one or more of rotors, propellers, blades, engines, motors, wheels, axles, magnets, or nozzles, based on the specific type of aircraft. The propulsion mechanisms can enable the movable object to take off vertically from a surface or land vertically on a surface without requiring any horizontal movement of the movable object (e.g., without traveling down a runway). Optionally, the propulsion mechanisms can be operable to permit the movable object to hover in the air at a specified position and/or orientation.

The sensing system 609 can include one or more sensors that may sense the spatial disposition, velocity, and/or acceleration of the movable object (e.g., with respect to up to three degrees of translation and up to three degrees of rotation). The one or more sensors can include global positioning system (GPS) sensors, motion sensors, inertial sensors, proximity sensors, or image sensors. The sensing data provided by the sensing system can be used to control the spatial disposition, velocity, and/or orientation of the movable object. Alternatively, the sensing system can be used to provide data regarding the environment surrounding the movable object, such as weather conditions, proximity to potential obstacles, location of geographical features, location of manmade structures, and the like.

The communication system may provide a primary communication channel (e.g., high bandwidth link) 621 and a core communication channel (e.g., low bandwidth link) 623. In some cases, the primary communication channel may be a high bandwidth link and the core communication channel may include a low bandwidth link. The primary communication channel 621 enables communication between the primary flight computer 601 and a primary ground computer 631 via wireless signals. The data transmitted via the downlink of the primary communication channel may be used for rendering a virtual reality representation on a virtual reality interface 633 to a remote pilot 640. Immersive video stream 625 such as encoded video data may be transmitted from the movable object to the primary ground computer 631 via a downlink. The primary ground computer 631 may transmit various control signals 627 (e.g., application kit commands) to the movable object via an uplink. Each of the uplink and the downlink may be wireless link. The wireless link may include a RF (radio frequency) link, a Wi-Fi link, a Bluetooth link, a 3G, 4G, 5G link, or a LTE link. The wireless link may be used for transmission of image data or control data over long distances. For example, the wireless link may be used over distances equal to or greater than about 5 m, 10 m, 15 m, 20 m, 25 m, 50 m, 100 m, 150 m, 200 m, 250 m, 300 m, 400 m, 500 m, 750 m, 1000 m, 1250 m, 1500 m, 1750 m, 2000 m, 2500 m, 3000 m, 3500 m, 4000 m, 4500 m, 5000 m, 6000 m, 7000 m, 8000 m, 9000 m, or 10000 m.

The core communication channel 623 enables communication between the core flight computer 607 and a core ground computer 651 via wireless signals. Data transmitted via the core communication channel 629 (e.g., basic black box data, attitude data, low bandwidth video data, pilot input) may be used for direct control of the aircraft (e.g., navigation, flight control). The pilot 640 may provide pilot input via the pilot harness MCU 659 to the core ground computer MCU 651 such as via the cyclic, alter collective, or pedals of the pilot control interface. FIG. 7 shows examples of the pilot interface 701 in communication with the core ground computer MCU 707 and the pilot harness MCU 703 that is configured to receive and process inputs from a remote pilot 705. The tilt chair harness beneficially provides mechanical feedback to the remote pilot to simulated cockpit environment. The communication systems may include any number of transmitters, receivers, and/or transceivers suitable for wireless communication.

The core ground computer may process the downlink data 629 to assist the pilot via tilt chair harness MCU 653, core video interface 655, core radio interface 657 and pilot harness MCU 659. The primary ground computer 631 may process the immersive video stream and assist the pilot via a VR interface 633, as well as provide high bandwidth data logging 635.

Referring back to FIG. 1, the system may comprise a vision and perception system implemented by onboard processors (e.g., GPU). The vision and perception system may implement artificial intelligence algorithms to process the video and sensor data.

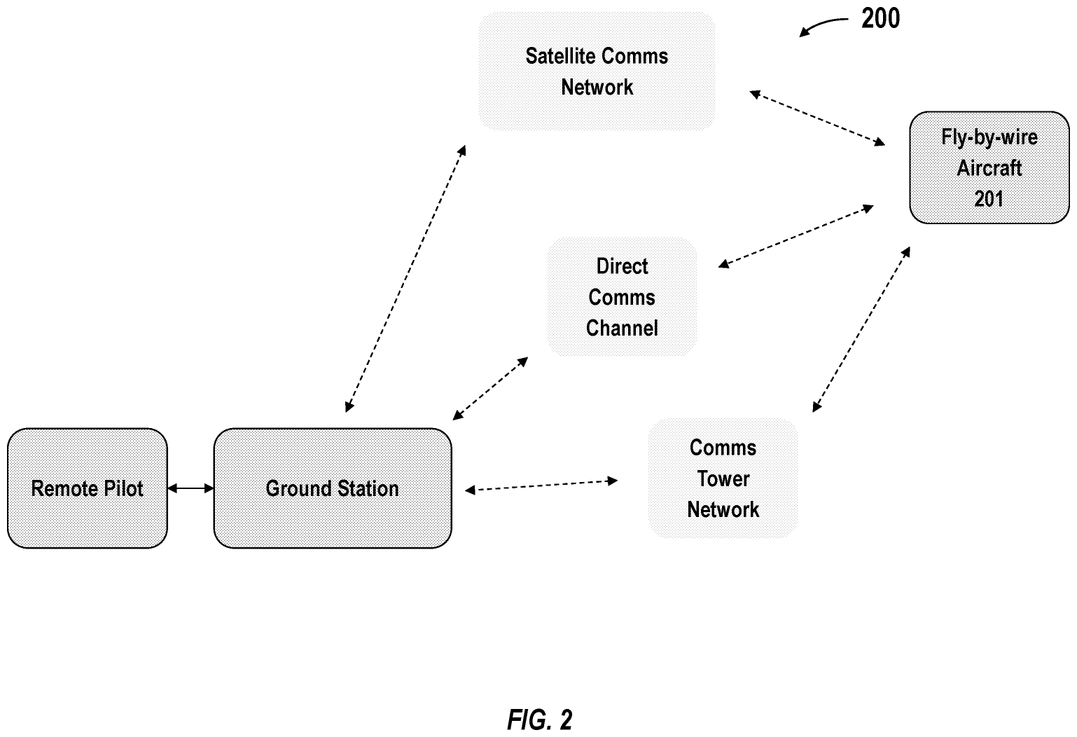

FIG. 2 schematically illustrates the architecture of the system 200 for remote controlling of an aircraft. In some embodiments, the helicopter may comprise a fly-by-wire actuation of vehicle control surfaces 201. The fly-by-wire systems 201 may interpret the pilot's control inputs as a desired outcome and calculate the control surface positions required to achieve that outcome. For example, rudder, elevator, aileron, flaps and engine controls may be controlled in response to the control signals using a closed feedback loop.

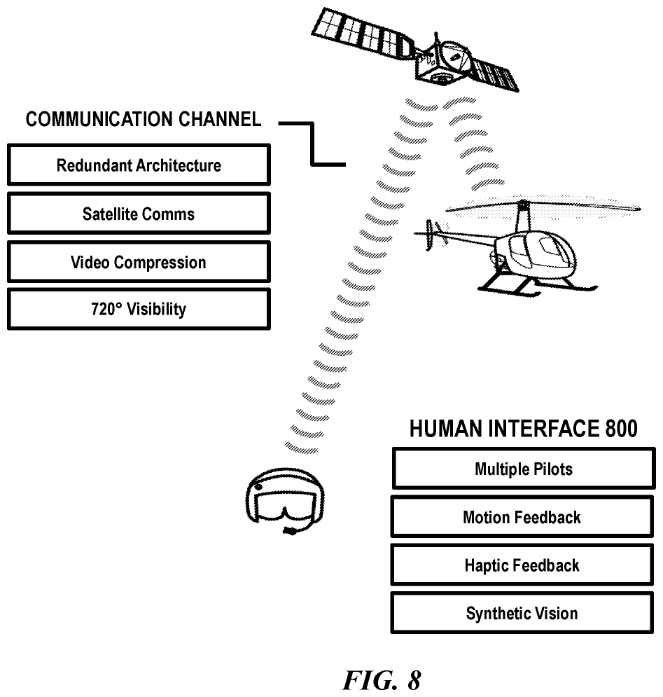

FIG. 8 schematically illustrates a user interface 800 provided at the remote control station. In some embodiments, the user interface may allow for multiple pilots: receive multiple control inputs, provide motion feedback, haptic feedback and synthetic vision to a remote pilot/operator. In some cases, visual feedback may be provided via a display device including a head-mounted display (HMD), or a pair of virtual reality (VR) or augmented reality (AR) enabled glasses. In some instances, the display device may comprise a mobile device mounted onto a foldable headgear. In some cases, the display device may be a hand-held device or in any suitable form. The mobile device may comprise a graphical display configured to display a FPV of the environment.

The human interface 800 may be configured to receive video data transmitted from the movable object via the communication channel, and display a FPV of the environment based at least in part on the video data. The human interface can also be used to control one or more motion characteristics of the movable object. For example, a pilot can use the human interface to navigate and control operation (e.g., movement) of the movable object based on the FPV of the environment. In some cases, the display device may be a pair of glasses or a head-mounted display worn on a user's head. In those cases, the user's head movement of the display device and/or eye movement may affect transmission/processing of the video data. The visual information displayed may actively adapt according to measurements of the movement of the human operator's head and/or eyes. For example, only the video data corresponding to the view where the user is looking at may be processed and/or transmitted.

In an aspect, a system for remote vehicle operation by human pilot is provided. The system may comprise: a vehicle capable of translational and rotational movement, a human operator and control station situated outside of the vehicle in a remote location, a bidirectional wireless communications channel, which transmits commands from the control station to the vehicle, and which receives information related to the vehicle's state and its environment from the vehicle, and a human interface device displaying information to the human operator, where the information displayed actively adapts according to measurements of the movement of the human operator's head and/or eyes.

In some embodiments, the vehicle is a helicopter. In some embodiments, the vehicle carries human passengers.

In some embodiments, a plurality of human interface devices allow a plurality of human operators to cooperate and control the vehicle. In some embodiments, the human interface device allows passive human participants to receive real-time information from the vehicle without access to direct control of the vehicle. In some embodiments, the human interface device comprises a motion feedback device providing physical movement or tactile feedback to the operator in response to the vehicle's state or environment.

In some embodiments, the image streams from multiple cameras onboard the vehicle are combined to produce a single image stream of a larger field of view. In some cases, the corresponding image processing is performed by a computer processor onboard the craft. For example, the onboard processing combines information from auxiliary sensors onboard the craft (e.g., an inertial measurement sensor) to overlay an artificial horizon directly within the produced video stream. In some cases, the onboard processing detects hazards such as power lines or other aircraft and highlights them in the produced video stream.

In some embodiments, the communication link between control station and craft is accomplished via a satellite-based communications network, an aircraft-based communications network, a network of ground-based communications beacons, or a combination of any. In some embodiments, a computer onboard the craft pre-processes pilot input before transmission to the actuators, providing additional stabilization and other forms of pilot assistance.

Improved Situational Awareness. The present disclosure provides systems and methods allowing for improved state awareness and situational awareness beyond the capabilities of conventional in-vehicle piloting. Systems and methods herein may present a remote pilot with visual and sensory information similar to that available in the vehicle. This may beneficially reduce disorientation stemming from physical detachment from the vehicle, which has been a problem in remote pilot systems to date, thus enabling safe, effective navigation and operation.

The system may further improve a remote pilot's situational awareness by removing the spatial and visibility constraints of a physical internal vehicle cockpit, and by leveraging omni-directional cameras and onboard computer processing to provide immersive synthetic vision. Such improved remote control mechanism and methods may allow the vehicles to be used in challenging conditions and complex tasks, such aircraft piloting, in particular at night or in degraded visual conditions (e.g., in cloud, fog, or smoke).

Mitigating Communications Limitations. The present disclosure provides systems and methods for mitigating the challenges typically created by the dislocation of the pilot from the vehicle. The limitations of the wireless communications between pilot and vehicle will constrain the amount of information that can be transmitted (i.e., bandwidth), add delays to the receipt of the information (i.e., latency), and may cause interruptions to the transmission of data (i.e., intermittency). Systems herein provide a framework of digital communications and use a combination of measures implemented onboard the vehicle, in the management of the communications links, and in the control station to mitigate these challenges. When implemented as an entire system, the present disclosure is able to provide for safe, reliable, and high-performance piloting even under severely challenging bandwidth, latency, and intermittency conditions.

Digital Control Components. In some embodiments, the system may comprise (1) an on-board control mechanism by combining onboard sensors with fly-by-wire or other digital actuation of vehicle control mechanisms (e.g., steering column, propulsion system, aerodynamic control surfaces), (2) a digital communications channel from vehicle to the pilot control station which may be multi-modal and actively managed, and (3) an immersive simulated cockpit environment which displays data to the pilot via digital displays and other types of human machine interface.

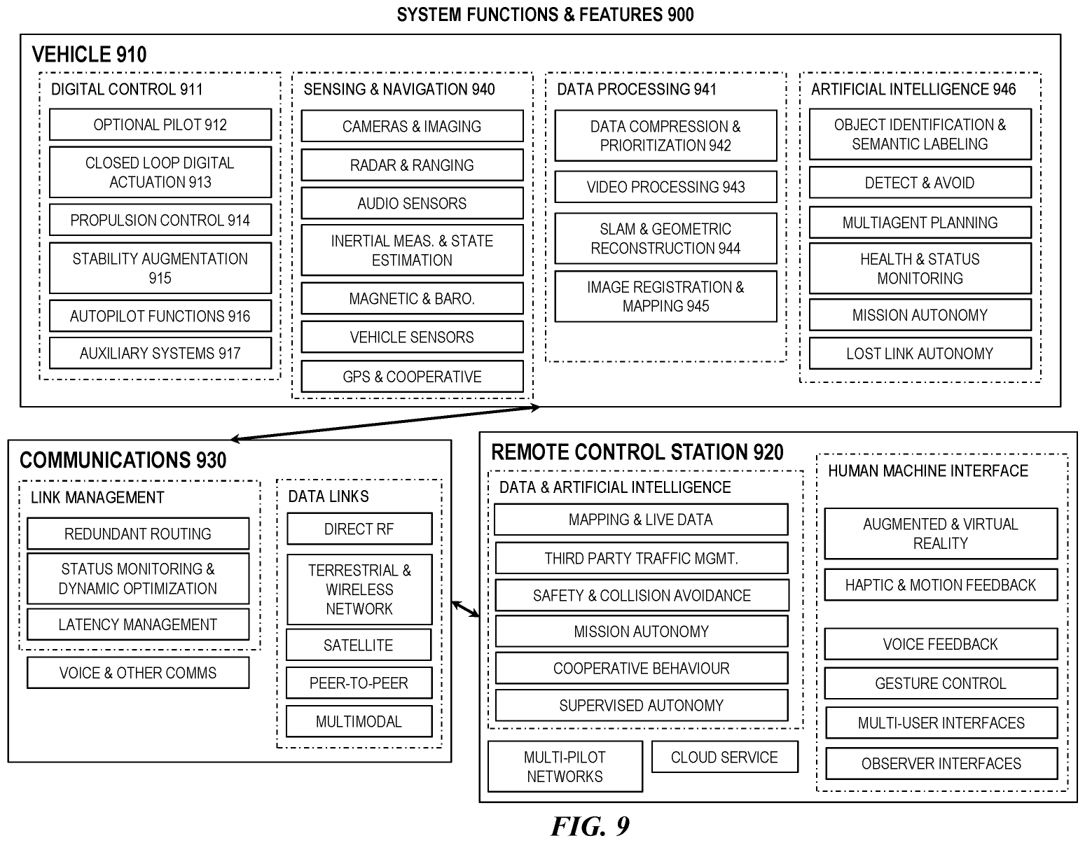

FIG. 9 schematically shows the functional structure for a system 900 for remote controlling a vehicle 910. Functions and features of the system 900 may be implemented as part of the vehicle 910, a remote control station 920, and a communications system 930.

Remote Control Station 920. In some cases, an operator or a pilot as well as some of the automated piloting functions may be located in the remote control station. The remote control station 903 may be situated outside of the vehicle and connected to the vehicle by wireless communications links. The remote control station is able to control the vehicle in real-time using data transmitted from the vehicle to perform tasks and missions as if the pilot were located in the vehicle itself. Certain aspects of the invention significantly increase the capability of the remote pilot and the information available to them compared to a conventional onboard pilot.

Digital Control. Digital control systems 911 onboard the vehicle may allow for the control of the vehicle by a remote pilot. In some embodiments, the digital control system 911 may comprise low-level control and actuation systems that directly control motors, actuators, auxiliary systems, and other vehicle functions, as well as higher level controllers which change the dynamic response of the vehicle and provide autopilot functions.

Optional Onboard Pilot. In some embodiments, the piloting of vehicles may not require a pilot onboard. Alternatively or additionally, an optional pilot 912 may be accommodated onboard. Digital control systems 911 described herein may be configured to act in conjunction with physical controls—either digital, mechanical, or otherwise—provided to a pilot physically in the vehicle. Control of the vehicle may be performed by either the onboard pilot or by a remote pilot, or both in conjunction. In some cases, friction clutches or other mechanical or digital failsafe and override mechanisms may be used to transfer control between an optional onboard pilot and a remote pilot.

Digital Actuation. The vehicle may be controlled by a digital actuation system 913. The digital actuation system 913 may use digital signals to command motors, actuators, and other systems onboard the vehicle to control and/or pilot the vehicle. In some embodiments, the digital actuation system may use sensors to read certain parameters or states of the vehicle to achieve closed loop control, e.g., closed-loop position control for an actuator.

Propulsion Control. The propulsion system may similarly be controlled with a closed-loop digital control system 914. For example, a closed-loop RPM control may be employed for a motor or a full authority digital engine control (FADEC) system for a piston engine or gas turbine. Propulsion mechanisms can include one or more of rotors, propellers, blades, engines, motors, wheels, axles, magnets, or nozzles, depending on the specific type of vehicle and as described elsewhere herein.

Stability Augmentation 915. The onboard digital control and actuation system may use closed-loop control to increase the stability, controllability, or other dynamic characteristics of the vehicle, or otherwise affect its operating envelope by providing for envelope protection, overspeed protection, or other safety and performance functions. For example, a non-linear control system may be used to increase the stability of helicopters and automatically maintain the helicopter in hover without any control inputs from the pilot. These stability augmentation systems may be “always on”, or they may be enabled or disabled or adjusted according to the pilot and mission needs.

Autopilot 916. An onboard autopilot may reduce pilot workload by automating certain piloting functions such as maintaining a certain position or velocity profile. Examples of autopilot may include position hold (e.g., autohover) and velocity hold (e.g., “cruise control”) functions, as well as the following of certain routes or flight paths that may be pre-determined or input by the pilot (e.g., waypoint following, automatic parking).

Auxiliary Systems 917. The vehicle auxiliary systems such as lights, entertainment systems, voice intercoms, and others may also be controlled digitally.

Sensing and Navigation 940. The vehicle may have onboard sensors and devices that sense both extrinsically (i.e., outside the vehicle) and intrinsically (i.e., internal parameters). Telemetry data produced by sensors may be transmitted from the vehicle to the remote control station. The sensing system can be the same as those described elsewhere herein.

Cameras and Imaging. The onboard sensors may comprise one or more digital imaging devices (e.g., camera). The imaging devices may capture different wavelengths of electromagnetic radiation (e.g. InfraRed, UltraViolet) with different resolutions and different fields of view. Image streams (i.e., video) from onboard cameras may be combined together allowing for an effective field of view greater than that afforded to a pilot inside a conventional vehicle. For instance, the video streams may be used to construct a 720 degree of solid angle (i.e., full omnidirectional) virtual view to an operator/pilot without obstruction. For instance, the pilot may be able to see underneath the cockpit without obstruction.

RADAR and Ranging. RADAR, LIDAR, SONAR, other time-of-flight, and doppler ranging or depth sensors may be used to determine the proximity, location, velocity, material, and shape of objects around the vehicle.

Audio Sensors. Audio sensors may be used to monitor external agents (e.g., to detect the proximity of other vehicles and objects) and surroundings as well as to monitor vehicle internal systems such as mechanical system health or to monitor passengers and payloads.

Inertial Measurement and State Estimation, Magnetic and Barometric Sensors. Telemetry data produced by the sensors may include the vehicle orientation, altitude, velocity, and/or accelerations, estimated forces and torques being applied by the environment against the vehicle or its control surfaces. Some examples of types of sensors may include location sensors (e.g., global positioning system (GPS) sensors, mobile device transmitters enabling location triangulation), inertial sensors (e.g., accelerometers, gyroscopes, and/or gravity detection sensors, which may form inertial measurement units (IMUs)), altitude sensors, attitude sensors (e.g., compasses), pressure sensors (e.g., barometers), temperature sensors, humidity sensors, vibration sensors, audio sensors (e.g., microphones), and/or field sensors (e.g., magnetometers, electromagnetic sensors, radio sensors) and various others.

Vehicle Sensors. Other vehicle sensors, for example used to enable closed-loop digital control, may be located onboard the vehicle. These myriad sensors may include those related to passengers, payloads, wear and tear, vibration, error and fault detection, and vehicle protection.

Vehicle Data Processing 941. Data from vehicle sensors and digital control systems may be processed onboard either to enable more efficient transmission to the remote control station, for mapping, or to provide data in a suitable form for onboard control and artificial intelligence.

Data Compression and Prioritization 942. Data from sensors may be compressed, sampled, or otherwise processed before transmission to the remote control station. This process may eliminate duplicate data, reduce data frequency, normalize data frequency, exclude erroneous data, or otherwise improve data quality or reduce data bandwidth. Additionally, onboard data may be prioritized so that more critical data is sent first before less critical data; the selection of what data to preferentially transmit may be adjusted in real-time to the available communications bandwidth.

Video Processing 943. In some cases, systems and methods herein may provide a proprietary encoding algorithm such as applying a multi-view video coding format to the raw video data. The encoding algorithm may comprise correlating the raw video data obtained by the one or more imaging devices, and reducing information redundancy in the raw video data. The raw video data may be encoded by the one or more processors onboard substantially in or near real-time as the raw video data is being captured by the one or more imaging devices.

SLAM and Geometric Reconstruction 944, Image Registration and Mapping 945. Onboard systems may use algorithms for simultaneous localization and mapping (SLAM) or geometric reconstruction to use information from imaging, ranging, and other sensors over time to produce a map or geometric reconstruction of the environment around the vehicle. This may include tracking moving objects of interest. A process of image registration and mapping may be used to create a consistent image or map from a sequence of images. For example, image registration and mapping may be used to augment or update pre-existing maps, e.g., using real-time color image data to colorize a known mesh or point cloud.

Artificial Intelligence 946. Some autonomous or artificial intelligence functions may be used onboard the aircraft to augment the capability of the pilot in the remote control station, to reduce their workload, to enable a single pilot to control multiple vehicles, or to take over the control of the vehicle when there is a loss of communications or slow communications.

Object Identification and Semantic Labeling. Computer vision and object identification algorithms may be used onboard the vehicle to identify objects detected by sensors and label them semantically. The computer vision and/or object recognition of identification algorithm may be deep learning models that are trained as described elsewhere herein. In some cases, the deep learning models may function as a compression mechanism to convert raster images to vector semantic data. For instance, upon identification of one or more objects in the scene, instead of transmitting the original image or video data, a vector semantic data related to the identified object (e.g., identity, location, etc.) may be generated and transmitted to the control station for construct a virtual view. This beneficially reduces the bandwidth required to transmit data to the remote control station. This can also be used so that other artificial intelligence algorithms may make actional decisions according to the detected objects.

Detect and Avoid. The artificial intelligence system may automatically detect other vehicles or moving objects and perform avoidance maneuvers such as changing the trajectory of the vehicle, warning the pilot, or automatically bringing the vehicle to a stop.

Multiagent Planning. The artificial intelligence system may perform advanced autonomous features wherein the system uses machine learning algorithm trained models for predicting the behavior of other agents (e.g., other vehicles, pedestrians, birds) to take actions which account for their expected behavior and adapts its own control actions of the vehicle to achieve some goal or to avoid some undesirable outcome. For example, a trajectory and/or motion of a given vehicle may be calculated in real-time based on data about another vehicle's trajectory and/or motion to avoid collision or a achieve a mission (e.g., coordinate to lift an object or to perform surveillance or firefighting mission).

Machine Learning And Training Methods The systems herein may involve a plurality of models developed to make predictions. For example, a multiagent planning model or collision avoidance model may be trained and developed to take sensor data (e.g., real-time image, location, etc.) as input and output a prediction of the behavior of an object, likelihood of collision and the like. The various models herein may be developed by supervised learning, unsupervised learning and/or semi-supervised learning. The term “labeled dataset,” as used herein, generally refers to a paired dataset used for training a model using supervised learning. The term “label” or “label data” as used herein, generally refers to ground truth data. During a training process, the weights or parameters of a deep learning model (e.g., CNN) are tuned to approximate the ground truth data thereby learning a mapping from input sensor data to the desired output.

A model may be a trained model or trained using machine learning algorithm. The machine learning algorithm can be any type of machine learning network such as: a support vector machine (SVM), a naïve Bayes classification, a linear regression model, a quantile regression model, a logistic regression model, a random forest, a neural network, convolutional neural network CNN, recurrent neural network RNN, a gradient-boosted classifier or repressor, or another supervised or unsupervised machine learning algorithm (e.g., generative adversarial network (GAN), Cycle-GAN, etc.). In some cases, the model may be trained, developed, continual trained-retrained on a cloud and the model may be deployed to the local system (e.g., remote control station or onboard the vehicle).

In some cases, the model may be a deep learning model. The deep learning model can employ any type of neural network model, such as a feedforward neural network, radial basis function network, recurrent neural network, convolutional neural network, deep residual learning network and the like. In some embodiments, the deep learning algorithm may be convolutional neural network (CNN). The model network may be a deep learning network such as CNN that may comprise multiple layers. For example, the CNN model may comprise at least an input layer, a number of hidden layers and an output layer. A CNN model may comprise any total number of layers, and any number of hidden layers. The simplest architecture of a neural network starts with an input layer followed by a sequence of intermediate or hidden layers, and ends with output layer. The hidden or intermediate layers may act as learnable feature extractors, while the output layer may output the improved image frame. Each layer of the neural network may comprise a number of neurons (or nodes). A neuron receives input that comes either directly from the input data (e.g., low quality image data etc.) or the output of other neurons, and performs a specific operation, e.g., summation. In some cases, a connection from an input to a neuron is associated with a weight (or weighting factor). In some cases, the neuron may sum up the products of all pairs of inputs and their associated weights. In some cases, the weighted sum is offset with a bias. In some cases, the output of a neuron may be gated using a threshold or activation function. The activation function may be linear or non-linear. The activation function may be, for example, a rectified linear unit (ReLU) activation function or other functions such as saturating hyperbolic tangent, identity, binary step, logistic, arcTan, softsign, parameteric rectified linear unit, exponential linear unit, softPlus, bent identity, softExponential, Sinusoid, Sinc, Gaussian, sigmoid functions, or any combination thereof. During a training process, the weights or parameters of the CNN are tuned to approximate the ground truth data thereby learning a mapping from the input sensor data (e.g., image data) to the desired output data (e.g., identity of object, location, orientation of an object in a 3D scene).

In some cases, the one or more models may be trained, developed, updated, and managed by a management system (residing on a cloud). In some cases, the management system may perform continual training or improvement after deployment. In some cases, the predictive or detective model utilized by the remote control system herein may be improved or updated continuously over time (e.g., during implementation, after deployment). Such continual training and improvement may be performed automatically with little user input. The management system can be applied in various scenarios such as in cloud or an on-premises environment.

Health and Status Monitoring. The artificial intelligence system may monitor the health and status of the vehicle to predict, detect, or mitigate error conditions, failures, and other disruptions. It may use machine learning or other data analysis algorithms for predict when components will fail or require maintenance; it may use insights to adapt the operation of the vehicle so as to minimize wear and tear or reduce the usage of consumables such as fuel, lubricant, or energy; it may take actions to minimize the effect of a failure of a system to the overall safety and functioning of the system overall.

Mission Autonomy. The artificial intelligence system may be configured or commanded to perform higher level mission functions autonomously, such as to survey a particular area, to travel from one position to another, to automatically load and unload payloads, or to cooperate with other vehicles or personnel to accomplish the purpose of a mission.

Lost Link Autonomy. The artificial intelligence system may enter special lost link autonomous modes upon detection of a loss of communications with the remote control station or the degradation of link quality. These lost link modes may maneuver the vehicle to attempt to reestablish a link, place the vehicle in a safe state, return the vehicle to a pre-determined home location or to a set of locations that are determined to be safe—or any combination thereof. For example, a lost link autonomous system for an aircraft may first turn the aircraft around to establish the link, automatically issue a mayday procedure, climb to a safe altitude to avoid terrain, and then automatically land at a safe airport or landing location.

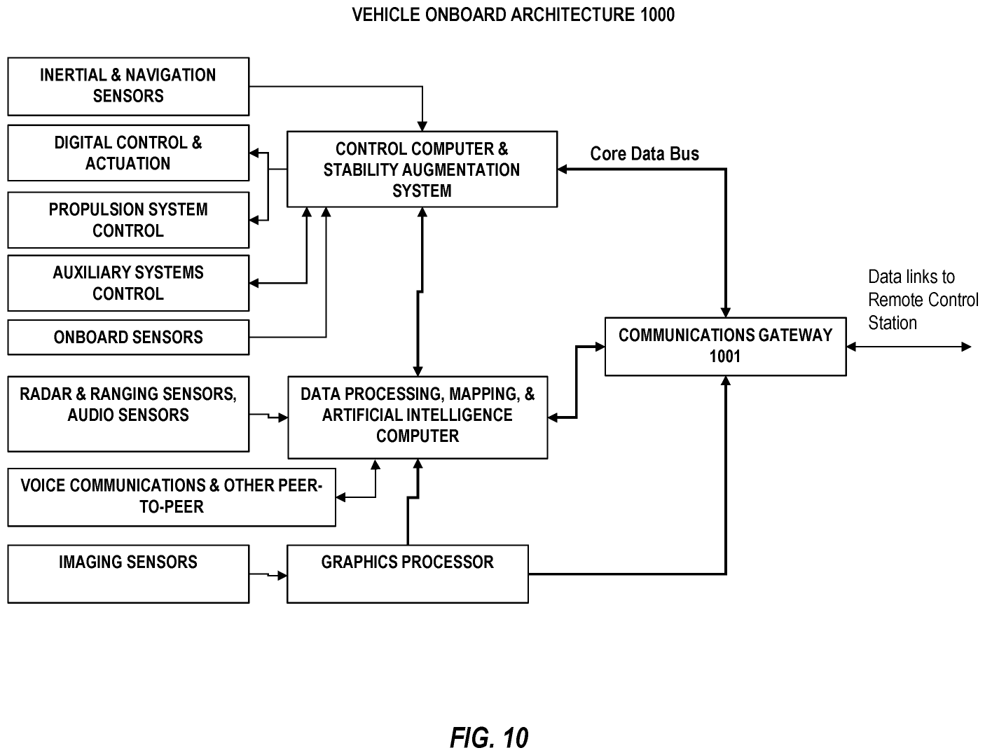

Vehicle Architecture. FIG. 10 schematically illustrates the architecture of sub-systems 1000 located onboard a vehicle. The system of the present disclosure may comprise sub-systems located onboard a vehicle. A set of onboard computers and processors (which may be physically located in the same computer or chip, or may be in separate physical units) perform functions related to the remote piloting of the vehicle and share data between each other and with the communications gateway through a core data bus. The computers communicate with sensors, actuators, and other types of system onboard the vehicle to accept inputs and provide outputs to support the control and actuation of the vehicle while collecting information about the vehicle and its environment. The data transmitted to the remote control station may be significantly modified by onboard processing in order to support transmission across communications links that may be limited in performance or by cost. A computer with artificial intelligence onboard may also perform many functions without the need for detailed instructions from human or autonomous pilots located in the remote control station.

Communications. A two-way wireless communications system between the vehicle and the remote control station is a core component of this invention. While individual communications links each have their specific bandwidth, latency, intermittency, range, cost, and regulatory constraints, architectures and systems of this invention can combine multiple communications links to maximize the performance of the overall remote piloting system.

Link Management. The link management system monitors the status and quality of multiple communications links to switch between them. The individual links may be multimodal, duplicative, etc., but they are abstracted by the link management system so that other the vehicle can treat the multitude of communications links as a single communications system. As part of the performance optimization to enable the maximum performance to be achieved at any time with the given communications resources at minimum cost, the link management may specifically perform the following tasks: use multiple links for the same information so that redundancy for mission-critical information is guaranteed; continuously monitor the status of each link and adapt its routing algorithm accordingly; take into account the latency (i.e., time taken for data to travel between vehicle and control station) so that messages can be delivered in the most timely manner and so that asynchronous messages can be deconflicted and converted into a smooth, continuous data feed.

Data Links. Depending on the application and the physical distance between remote control station and aircraft, a data link may be a direct line-of-sight radio or other electromagnetic communications, or employ a more complex communications scheme reliant on a network of ground-, aircraft-, or satellite-based repeaters for the transmission.

Direct RF Link. The wireless link may be a single RF (radio frequency) link which uses any frequency of electromagnetic wave traveling through air or vacuum to encode information. Examples of terrestrial links include Wi-Fi, WiMax, Zigbee, M-Bus, LoRa, Sigfox, IEEE802.15.4, Bluetooth, UHF, VHF, 2G, 3G, 4G LTE, 5G links, or others. The wireless link may be used for transmission of data over short or long distances. RF data links may use a broad spectrum of frequencies and use sophisticated algorithms for allocating frequency bands or time segments and hopping between them.

Terrestrial Networks. Terrestrial networks may be used to extend the range of direct RF links; these include wireless transmission between repeaters (e.g., cell repeater towers) and wired transmission through networks that use various types of conducting or fiber optical methods for transmitting data (e.g., internet).

Satellite. Satellites orbiting the Earth or other space-based nodes may be used to relay information from the vehicle to the control station directly or through a gateway located terrestrially. Dedicated satellites may be used, or constellations such as Viasat, Eutelsat, Inmarsat, SpaceX Starlink, OneWeb, Iridium, Thuraya, European Aviation Network, 3GPP, satellite-based 5G, ligado, omnispace, Inmarsat Orchestra, or others.

Peer-to-Peer. Ranges of RF transmission can be extended by vehicle-based peer-to-peer networks where multiple vehicles may relay information to each other via wireless transmission nodes onboard each vehicle. Some of these vehicles may be controlled by similar remote piloting systems, some vehicles may only carry passive communications relays.

Multimodal. Links may be combined together into a single multimodal link to extend range, improve coverage, or otherwise increase the capability of a single link. For example, a vehicle with a RF connection to another vehicle may use that peer vehicle's satellite communications system to transmit data to a satellite ground terminal which then uses a terrestrial wired communications link (e.g., internet) to transmit data to the remote control station—in this case, three modes of communication are used in a single link: peer-to-peer RF, satellite, terrestrial.

Voice & Other Comms. The vehicle may also have provision for transmission of other analog or digital communications outside of the set of managed links for primary communications with the ground controls station. For example, these can include Automatic Dependent Surveillance-Broadcast systems in aircraft, voice radio communications, or other types of radio-based ranging and communications. Voice radio communications and other analog communications may be transmitted over the digital communications system to the ground control station using a “voice over IP” protocol or similar.

High-reliability wireless communications While a number of mature communications technologies are available, e.g. terrestrial cellular networks, satellite communications, or line-of-sight radio links, the performance of these solutions vary widely in terms of bandwidth, latency, and ultimate reliability. For example, direct radio links may provide very high data rates and low latency (e.g., up to 1 Gbps at less than 50 ms latency), but they require direct line-of-sight (LoS) between ground station and aircraft-mounted antenna and may fail due to intervening terrain or even adverse orientations of the aircraft. In contrast, satellite communications can achieve much wider and more reliable coverage, requiring only a clear view of the sky, but these links are generally restricted to much lower data rates and longer latencies. These large latencies manifest as control delays between a remote operator and the target aircraft, and can make manual stabilization and control difficult or impossible. The communications architecture herein beneficially allows multiple heterogeneous wireless communication links to be deployed in unison, achieving a combined “fused” link that is redundant to dropouts by one or more of its constituent physical links. Besides achieving an ultimate wireless communications reliability that surpasses the individual reliability of any individual physical link, this is done in a way that makes opportunistic use of higher data rates and lower latencies as they are available.

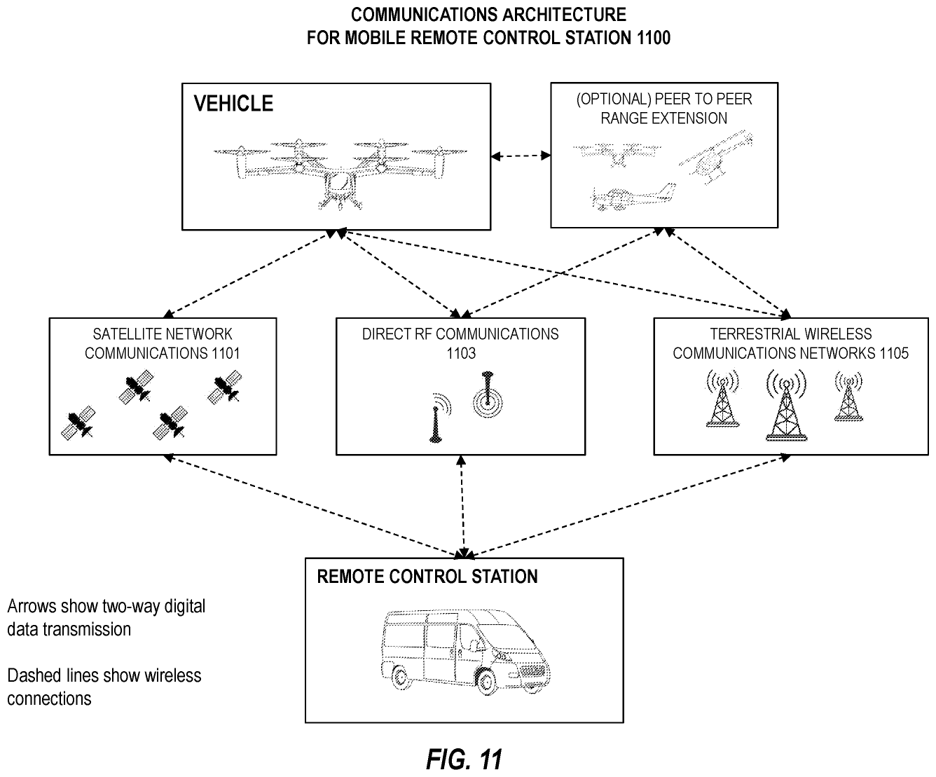

Communications Architecture. FIG. 11 schematically illustrates the architecture of a communications system 1100 between the vehicle and a mobile remote control station. The system herein may comprise sub-systems for communication 1100 between a remote control station that is mobile and a vehicle. The remote control station may rely on wireless communications. For example, the wireless communications may include satellites network communication 1101, direct link to the vehicle (e.g., direct radio frequency (RF) communication 1103), or through a terrestrial wireless communications network 1105 or a combination of any of the above. In some cases, the range of these communications links may be increased by optional peer to peer range extension between vehicles.

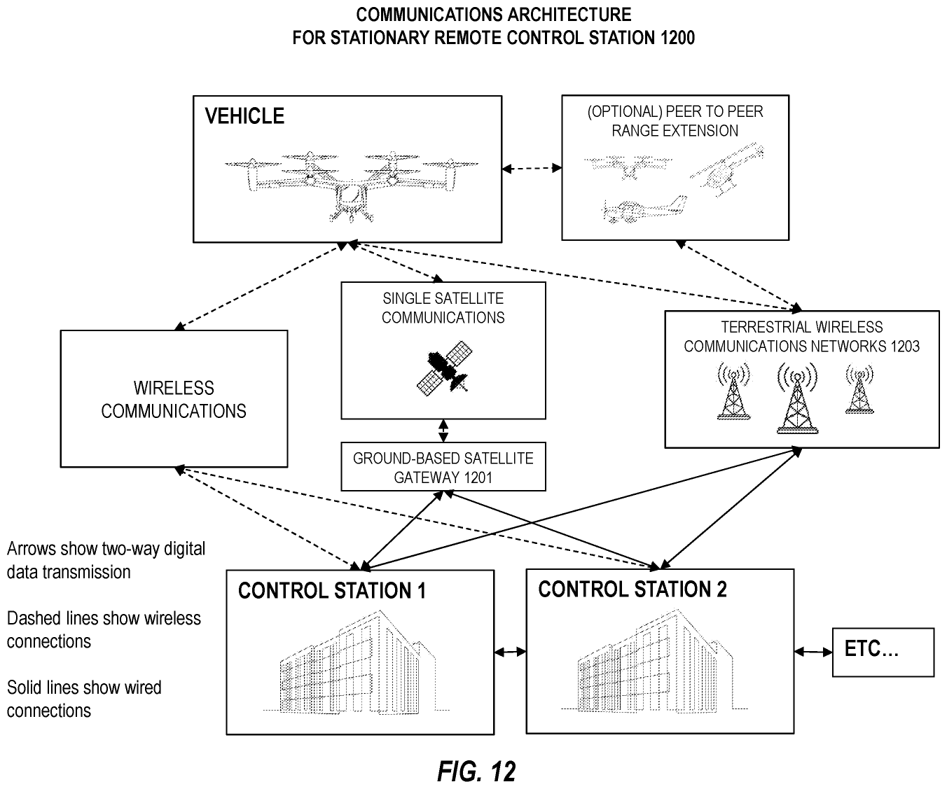

FIG. 12 schematically illustrates the architecture of a communications system 1200 between the vehicle and a stationary remote control station. Additionally to the wireless communications described above, the fixed control station is able to use satellite communications that require a fixed ground-based satellite gateway 1201 and terrestrial wireless communications networks 1203 that have a wired connection to control station. The use of wired connections may increase the reliability and reduce the cost of the overall communications system. Additionally, it allows greater ease of connection between different control stations which may be separated geographically.

In some cases, a plurality of bidirectional physical communication links (e.g., links 1101, 1103, 1105) is deployed, with a fixed prioritization established among the physical links. This prioritization may reflect the relative performance (data rate and latency) of the links, with lower-latency, higher-bandwidth links being assigned higher priorities, and higher-latency, lower-bandwidth links receiving lower priorities. In some embodiments, each physical link is associated with an abstracting interface computer, which monitors the connectivity status of the physical link and adapts link-specific input/output data stream formats into a common interface such as UDP/IP. Additionally, the interface computers may be responsible for applying error-correcting codes to outbound traffic, and decoding inbound traffic. This allows the choice of error correction codes to be made independently for each channel.

In some cases, a specialized network switch computer, such as a multiplexing/broadcast gateway (MBG), may combine the multiple physical links into a single, virtual data link that connects to the digital fly-by-wire computers. The multiplexing gateway may implement the various features such as the outbound and inbound data routing as described elsewhere herein. FIG. 10 shows an example of the multiplexing/broadcast gateway (MBG) 1001. As will be described in detail below, the MBG broadcasts outbound data, duplicating flight-critical telemetry and sensor data across multiple physical links to achieve a high degree of redundancy, while multiplexing between redundant input links, ensuring that the highest-priority (lowest-latency) available input stream is passed to the onboard flight controls. In some cases, the MBG reports its current status to the fly-by-wire system, which ensures that the proper control mode is in use given the latency of the best currently-available physical link.

In some cases, data budgets may be defined for each physical link. In order to achieve meaningful redundancy against failure of individual links, crucial data streams may be duplicated across physical links to the greatest extent possible.

The routing of outbound data (e.g., from the vehicle to the ground station) may follow a quasi-broadcast pattern. For example, each data stream (e.g., Standard-Resolution Video) is duplicated over each physical link that is specified to support it, according to the pre-specified link budgets. This ensures that critical streams, like basic telemetry, are transmitted with a high degree of redundancy, while less critical streams, such as high-resolution video, are only transmitted on physical links which have the additional bandwidth to support them.

Routing inbound data (e.g., from the ground station to the vehicle) can be complicated. As in the outbound case, critical inbound data can be duplicated across as many physical links as possible to achieve desired redundancy. However, only one source can be effectively passed through the MBG for use by the onboard flight control computers. It is desirable that the lowest-latency available data source be the one passed through. This is accomplished in the MBS by active monitoring of each physical link, and automatic switching to the highest-priority (i.e., “best”) source available as individual links are periodically lost and recovered.

Control Modes In some embodiments, the remote control may have several control modes and may switch between the control modes based at least in part on the stability or availability of the communication links. For example, a semi-stabilized manual mode may be triggered when a reasonably low-latency link is available (e.g., a direct radio connection between aircraft and ground station), the remote pilot can be trusted with a more flexible control, and with more responsibility in terms of stabilizing the craft. However, latencies may be relatively large compared to traditional in-cockpit operation. The semi-stabilized manual mode may include attitude stabilization, where the pilot cyclic inputs are interpreted as a desired setpoint in aircraft pitch and roll, rather than mapping directly to the cyclic adjustment of the main rotor swash plate. Pilot rudder inputs may adjust a setpoint in aircraft heading, rather than mapping directly to tail rotor pitch. In this mode, the flight computer may automatically handle disturbance rejection, protect against unsafe flight states, and otherwise improve the flight handling characteristics of the aircraft, while maintaining a large degree of pilot flexibility. A “null” pilot input would correspond to holding the aircraft at a level attitude (though not necessarily at a stationary hover).

In some embodiments, the multiple control modes may include full-stabilized velocity mode. When only a high-latency communications link is available, the remote may can no longer be safely expected to stabilize the aircraft. In this condition, the automatic flight computer may take more responsibility for stabilization and safety, at the cost of providing the remote pilot with less flexible control. As compared to waypoint-sequencing, the traditional approach to remote operation of an aircraft, the “velocity-control” form of command maintains a large degree of operational flexibility. The operator/pilot may easily nudge the helicopter left or right to precisely position a slung load in a construction project, or control altitude smoothly during a water pickup, or hold a smooth cruise velocity during a dynamic water drop.

In some embodiments, the multiple control modes may include an autonomous waypoint mode. If only a very restricted link is available, only the most basic telemetry may be available to the remote operator, and input latencies may be too great to ensure safe operation. In such a case, the system may revert to a more conventional waypoint-following mode, in which a remote operator simply designates a flight path via a series of waypoints on a screen.

In some embodiments, the multiple control modes may include a return-home mode. In the event that all communication links are lost, the flight control computer may be completely on its own to stabilize the aircraft and avoid catastrophic collision with terrain or other hazards. As no pilot input is available in this mode, all mission objectives are ignored, and safe recovery of the aircraft becomes the first priority. As an example, the return-home mode may include an auto-hover until either a communication link is re-established or a prespecified duration has elapsed. In the latter event, the system may fly back to a pre-specified safe location and perform an auto-land.

In some cases, switching between the control modes may require the pilot to intentionally re-enable semi-stabilized mode upon each reacquisition of the low-latency channel. This ensures that the pilot is fully aware of, and ready for, any transition from fully-stabilized to semi-stabilized flight. On the occasion that the low-latency link is lost, the auto-pilot may immediately revert to fully-stabilized mode, providing both audible and visual notifications to the pilot alerting them to this event. While such a lost-link event is generally unpredictable and may catch the pilot off guard, the autopilot may be in position (within fully-stabilized mode) to immediately and safely stabilize the craft. The switching mechanism may also require that within semi-stabilized mode, the aircraft may not be allowed at any time to enter a state from which an immediate transition to fully-stabilized flight would be unsafe. This can be accomplished via “envelope-protection” within semi-stabilized mode, prohibiting the prescription of dangerous flight states (such as excessive roll angles).

Remote Control Station. The remote control station provides a human machine interface (HMI) for the pilot or pilots as well as other data and artificial intelligence functions. Because the remote control station may not be moving or may be in a more controlled environment than the vehicle itself, there are provisions for pilots, data, communications, which are significantly improved compared to what would be possible onboard the vehicle. For example, the fully-stabilized flight mode may include velocity control. In the fully-stabilized flight mode, the cyclic inputs may be interpreted to indicate setpoint in lateral (inertial) velocity. In this case, the neutral position (the “null” input) may correspond to a stable hover, and the automatic control may be responsible for rejecting disturbances and otherwise stabilizing the craft. Correspondingly, the collective stick may be interpreted to indicate a setpoint in altitude-rate. Rudder inputs may continue to indicate a heading setpoint, as in the semi-stabilized case.

Mapping and Live Data. The remote control station may display maps and other types of live data on the user interface to the pilot or to inform autonomous decision making. The live data may include maps of terrain, natural features, weather, other vehicles, and any other types of information of interest.

Third Party Traffic Management. The remote control station may communicate with third party traffic management systems informing them of the position of the vehicle and taking instructions from those traffic management systems on the control of the vehicle. This may be manual, e.g., voice communications with an air traffic control, or automated based on computer instructions.

Safety and Collision Avoidance, Mission Autonomy, Cooperative Behavior. While some artificial intelligence tools may be implemented onboard the aircraft itself, due to the greater information, computing power, and networked intelligence available in the remote control station, many safety, autonomy, and cooperative decision making functions may be implemented more effectively in the remote control station. In some cases, the system herein may provide cooperative autonomy, where multiple pilots or AIs with access to common information in the control station may be able to cooperatively control multiple aircraft in a centralized manner. This type of operation would not be impossible for aircraft and onboard pilots acting singly.

Supervised Autonomy. Artificial intelligence in the remote control station may reduce the need for a pilot to be performing low-level control or decision-making tasks as part of the mission and enable supervised autonomy where pilot intervention is infrequently needed and primarily required only to handle error or edge-case conditions which are difficult to manage using a fully-autonomous system. Supervision may also be an important part of training and validating an autonomous system.

Human Machine Interface. A human machine interface (HMI) to convey information to the pilot and receive command and control inputs from the pilot is an important component of the remote control station. In some embodiments, the HMI may comprise a simulated cockpit of the vehicle to replicate the pilot's experience in the vehicle itself, including the visual, audio, tactile, and motion cues that they would have experienced. In other embodiments, the HMI may be different to the vehicle and may be designed to improve the pilot performance or to reduce the cost of the HMI.

Wearable Displays. Visual cues relating to the vehicle surroundings, state, and other information may be and presented to the remote pilot(s) and operator(s) via a display device. The display device may include a wearable device. In some cases, the display device may be a pair of glasses, goggles, or a head-mounted display. The display device may include any type of wearable computer or device incorporating augmented reality (AR) or virtual reality (VR) technology. AR and VR involve computer-generated graphical interfaces that provide new ways for users to experience content. In augmented reality (AR), a computer-generated graphical interface may be superimposed over real world video or images on a display device. In virtual reality (VR), a user may be immersed in a computer-generated environment rendered on a display device. The display device provided herein may be configured to display a first person view (FPV) of the real world environment from the vehicle, in an AR setting or VR setting, or some other view either inside or outside of the vehicle. The visual information displayed may actively adapt according to measurements of the movement of the human operator's head and/or eyes. For example, only the video data corresponding to the view where the user is looking at may be processed and/or transmitted.

Augmented Reality. In some cases, auxiliary information such as vehicle orientation or the presence of relevant hazards such as power lines and other aircraft may be overlaid on imagery of the environment computer-generated graphics. Some of these overlays may highlight objects that are detected from the video data itself or from other sensors onboard the vehicle, some overlays may be generated from stored data (e.g., maps or terrain data) or data from external sources (e.g., an Automatic Dependent Surveillance-Broadcast system), and other overlays may be entirely artificially generated. In some cases, the entire digital pilot environment including the background environment may be generated with computer graphics and may be altered electronically to be different to the direct visual imagery captured by onboard cameras.

Haptic and Motion Feedback. In some cases, vehicle telemetry including vehicle orientation and accelerations may be communicated through a moving pilot seat or platform that is capable of up to six-axis motion. In some cases, haptic feedback on “stick and rudder” cockpit-style controls may communicate forces and torques experienced by the vehicle in real-time.

Voice Control. In some embodiments, voice command and control and a natural language processing system may enable the pilot to perform certain tasks using voice instructions. This may include transferring control of the vehicle between themselves (the pilot) and an autonomous system (e.g., by saying “you have controls”), or other tasks such as changing HMI display modes, receiving status updates, or managing auxiliary systems (e.g., lighting, radio frequencies, payloads, etc.)

Gesture Control. In some embodiments the HMI system may monitor the position of the pilot's body, including their eyes, head, hands, and feet and interpret gesture cues to perform command and control functions. For example, an operator may wave hands to begin certain maneuvers, to enter an emergency state, or provide other types of gesture-based control input that do not require the manipulation of a lever, button, screen, or other tactile device.

Multi-user Interfaces. In some embodiments, a plurality of human interface devices allows a plurality of human operators to cooperate and control the vehicle. In some embodiments, the human interface device allows passive human participants to receive real-time information from the vehicle without access to direct control of the vehicle. In some cases, the plurality of human interface devices may allow active human operators to control the vehicle and passive human participants to receive real-time information without active control of the vehicle.

Pilots In a Supervisory Role. In some embodiments or modes of operation, the pilot may take a supervisory role where they do not need to continuously or actively provide inputs to the vehicle in order for it to perform the intended mission. In this case, the pilot may only be required to set mission goals for the vehicle, to intervene in an off-nominal situation (e.g., in the event of a system failure), or if the vehicle is not operating as intended or desired. In some embodiments, one single pilot may supervise multiple vehicles at one time.

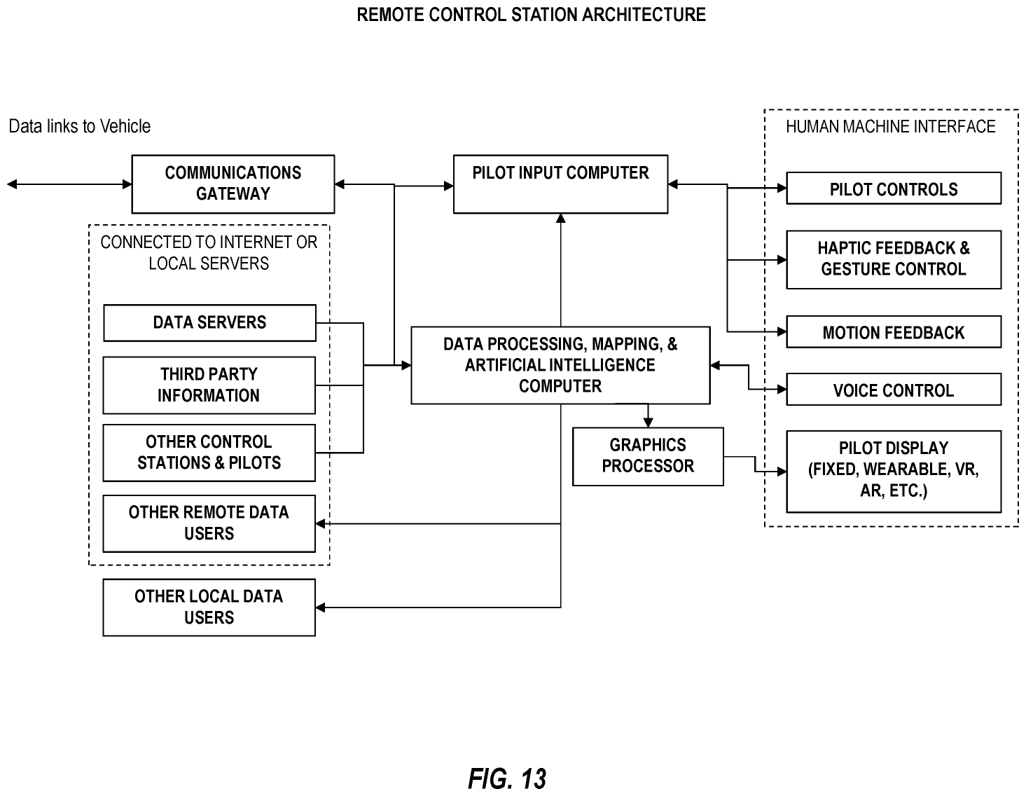

Control Station Architecture. FIG. 13 schematically illustrates the architecture of a remote control station. Data links from the vehicle and to internet or local servers provide vehicle information as well as information from a multitude of other possible sources. This information is processed by computers and displayed to the pilot through a human machine interface that can provide visual, audio, motion, and haptic feedback. The pilot's intentions are captured by the human machine interface and processed by a pilot input computer which transmits the interpreted intentions of the pilot to the vehicle. Data sharing with other pilots and users is possible and the relevant inputs to those interfaces is provided by a processor in the control station.

Network of Multiple Vehicles. Multiple vehicles may be piloted within the same piloting system. Vehicles within this system operate from a common set of data and shares data between the vehicles so that any single vehicle or autonomous system has more data and information regarding the environment. Networks of vehicles may be used to improve monitoring of wear and tear and maintenance, to increase the accuracy of vehicle metrics, and to reduce overall complexity and cost of vehicle management.

Network of Multiple Pilots. When there are multiple vehicles within the network, there may also be multiple pilots. Similarly to the vehicles, the pilots operate from a common set of data and are able to benefit from vehicle and environment information being gathered by the entire fleet of vehicles. In a dense operating environment, the system herein may allow for a plurality of pilots within the same network to be aware of other vehicles' (and their corresponding pilots') locations, trajectories, and intentions. This enables more effective deconfliction or cooperation. The system herein may provide pilots extrinsic sensing information gathered by other aircraft, for example mapping or weather observations provided by a different vehicle. This system of passive information sharing between pilots (i.e., without a pilot having to intentionally communicate about their intentions or surroundings) enables reduction of pilot workload while enabling significantly more data availability for pilots.

Network of Autonomous Systems. Networks of autonomous systems and autonomous functions that are implemented in the remote control station(s) are analogous to networks of human pilots in the remote control station(s): they are able to share data to improve decision-making. Autonomous safety functions such as collision avoidance benefit from knowing other vehicles' position and intentions; autonomous functions which rely on information about the environment (e.g., terrain avoidance for aircraft) benefit from having data that is being gathered by other vehicles about the operating environment and the position of objects of interest (e.g., other vehicles not within the network, pedestrians, fish, birds, rocks, aliens, etc.). In some cases, different autonomous systems may be assigned different tasks and some vehicles may have reduced extrinsic sensing capabilities and can rely on the complementary sensing capabilities of other vehicles.

Cooperation Between Autonomous Systems. In some embodiments, a higher level cooperation between autonomous system may be performed to achieve a common goal. The higher level cooperation may require multiple autonomous systems to understand each other's performance and capabilities, to co-optimize the respective trajectories, and to complete a mission as a team. This cooperative behavior can be explicit, that is using a single autonomous planner to concurrently plan the trajectories and behavior of multiple vehicles. Alternatively, the cooperation can be implicit, where each vehicle acts independently by has models and understanding about the mission objectives and expected behavior of other vehicles also working to complete the same task. An example of simple cooperative behavior between aircraft surveilling a certain area is for the aircraft to “divide and conquer” the area to be surveilled. An example of a complex task is for multiple aircraft to cooperatively lift a single object which is larger than the lifting capacity of each individual aircraft; this task requires dynamic adjustment of each vehicle's motion and behavior and coordinated in real-time.

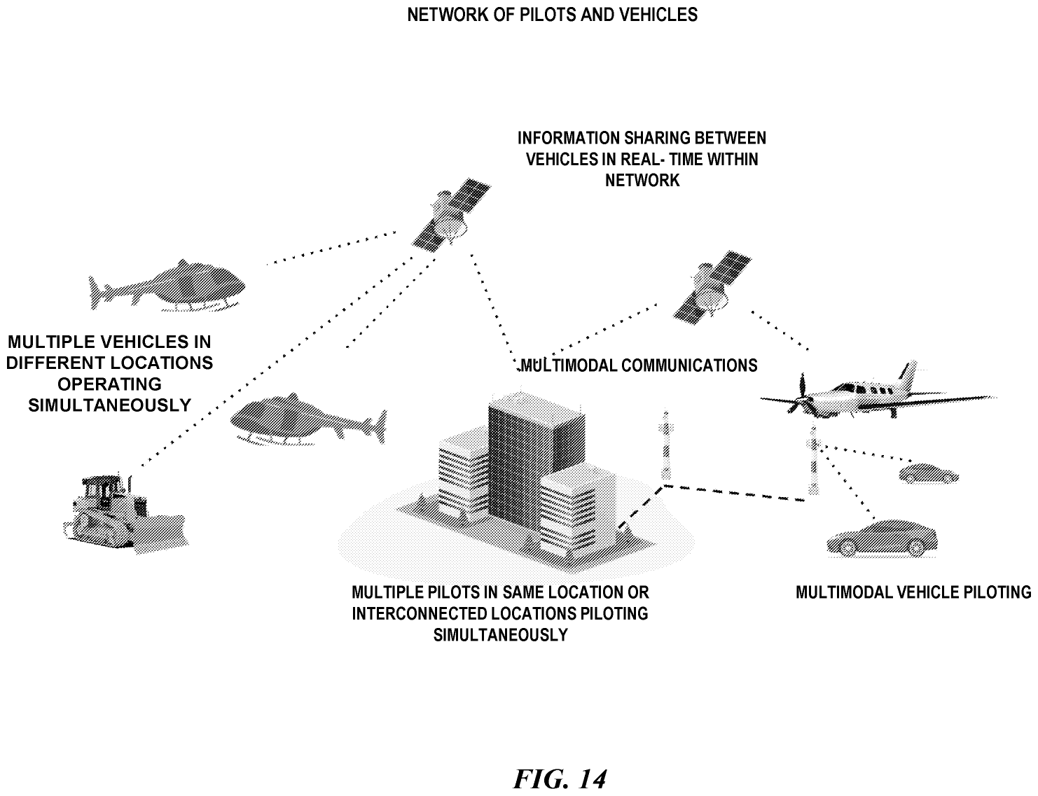

Switching Between Pilots and Aircraft, Cloud-based Piloting As A Service. In a system of many vehicles and many pilots, the allocation of pilots to aircraft may be flexible and dynamically adjusted. For instance, according to the availability of a pilot, a pilot within the network who is not piloting a vehicle may be assigned to a vehicle requiring a pilot, rather than designating a single pilot to a single vehicle (as is usually the case for in-person piloting). In some cases, the dynamic pilot assignment may be determined based on availability, past experience and/or other factors. The ability to dynamically allocate pilots may significantly increase the productivity and utilization of pilots in networks of sufficient size and in missions which cannot be regularly scheduled. Such dynamic pilot allocation may be a function of the remote piloting system as described in this paper and may be provided as the abstraction of piloting to a continuous resource (i.e., “as a service”), rather than tied to any single human pilot themselves. FIG. 14 shows a network of pilots and vehicles. The vehicles may be of different types while still sharing a single piloting and information network and the pilots may switch between multiple vehicles as demand for specific vehicles changes.

In an aspect, a system for remote vehicle operation by human pilot is provided. The system may comprise: a vehicle capable of translational and rotational movement, a human operator and control station situated outside of the vehicle in a remote location, a bidirectional wireless communications channel, which transmits commands from the control station to the vehicle, and which receives information related to the vehicle's state and its environment from the vehicle, and a human interface device displaying information to the human operator.

In some embodiments, the vehicle is a helicopter. In some embodiments, the vehicle carries human passengers.

In some embodiments, the image streams from multiple cameras onboard the vehicle are combined to produce a single image stream of a larger field of view. In some cases, the corresponding image processing is performed by a computer processor onboard the craft. For example, the onboard processing combines information from auxiliary sensors onboard the craft (e.g., an inertial measurement sensor) to overlay an artificial horizon directly within the produced video stream. In some cases, the onboard processing detects hazards such as power lines or other aircraft and highlights them in the produced video stream.

In some embodiments, the communication link between control station and craft is accomplished via a satellite-based communications network, an aircraft-based communications network, a network of ground-based communications beacons, or a combination of any. In some embodiments, a computer onboard the craft pre-processes pilot input before transmission to the actuators, providing additional stabilization and other forms of pilot assistance.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. Numerous different combinations of embodiments described herein are possible, and such combinations are considered part of the present disclosure. In addition, all features discussed in connection with any one embodiment herein can be readily adapted for use in other embodiments herein. It is intended that the following claims define the scope of the invention and that methods and structures within the scope of these claims and their equivalents be covered thereby.

1. A system for remote operation of a vehicle by human operator, comprising:
the vehicle comprising a fly-by-wire control system for controlling an actuator of the vehicle in response to a command received from the human operator located at a control station;
a bidirectional wireless communications system configured to transmit the command from the control station to the vehicle, and receive data related to the vehicle's state and an environment from the vehicle; and
a human interface device located at the control station remote from the vehicle, wherein the human interface device is configured to display a live virtual view constructed based at least in part on image data received from the vehicle.

2. The system of claim 1, wherein the vehicle is a helicopter.

3. The system of claim 1, wherein the vehicle comprises one or more processors to process sensor data collected by sensors onboard the vehicle, wherein the sensor data is processed by a machine learning algorithm trained model and wherein the processed sensor data comprises an object identified by the machine learning algorithm trained model.

4. (canceled)

5. The system of claim 1, wherein the bidirectional wireless communications system comprises a combination of a plurality of links including a satellites network communication link, a direct radio frequency communication link and a terrestrial wireless communication link and wherein the vehicle comprises a multiplexing gateway configured to duplicate critical telemetry data and broadcast over the plurality of links.

6. (canceled)

7. The system of claim 1, wherein the control station is stationary or mobile.

8. (canceled)

9. The system of claim 1, wherein the live virtual view is adaptively displayed according to a measurement of a movement of the human operator's head and/or eyes.

10. The system of claim 1, wherein the live virtual view is 720 degree.

11. A method for remote operation of a vehicle by human operator, comprising:
controlling, via a fly-by-wire control system, an actuator of the vehicle in response to a command received from the human operator located at a control station;
providing a bidirectional wireless communications system to transmit the command from the control station to the vehicle, and receive data related to the vehicle's state and an environment from the vehicle; and
displaying, via a human interface device located at the control station remote from the vehicle, a live virtual view constructed based at least in part on image data received from the vehicle.

12. The method of claim 11, wherein the vehicle is a helicopter.

13. The method of claim 11, wherein the vehicle comprises one or more processors to process sensor data collected by sensors onboard the vehicle, wherein the sensor data is processed by a machine learning algorithm trained model and wherein the processed sensor data comprises an object identified by the machine learning algorithm trained model.

14. (canceled)

15. The method of claim 11, wherein the bidirectional wireless communications system comprises a combination of a plurality of links including a satellites network communication link, a direct radio frequency communication link and a terrestrial wireless communication link and wherein the vehicle comprises a multiplexing gateway configured to duplicate critical telemetry data and broadcast over the plurality of links.

16. (canceled)

17. The method of claim 11, wherein the control station is stationary or mobile.

18. (canceled)

19. The method of claim 11, wherein the live virtual view is adaptively displayed according to a measurement of a movement of the human operator's head and/or eyes.

20. The method of claim 19, wherein the live virtual view is 720 degree.

21. The system of claim 1, wherein a plurality of the vehicles are operated by a network of human operators,
wherein each of the plurality of vehicles comprises a fly-by-wire control system for controlling an actuator of the respective vehicle in response to a respective command received from the control station,
and
wherein a computer system located at the control station is configured to aggregate the data received from the plurality of vehicles and display information to the network of human operators via a plurality of the human interface devices.

22. The system of claim 21, wherein the information is processed from data collected by complementary sensors located onboard different vehicles.

23. The system of claim 21, wherein at least one human operator is selected from the network of human operators and dynamically assigned to operate a vehicle from the plurality of vehicles.

24. The system of claim 21, wherein the respective command is generated using a machine learning algorithm trained model based on the data aggregated from the plurality of vehicles.

25. The system of claim 24, wherein a command for controlling a first vehicle from the plurality of vehicles is generated based at least in part on a behavior of a second vehicle from the plurality of vehicles.

26. The system of claim 21, wherein at least one of the plurality of human interface devices is configured to display the information and receive input from an active user from the network of human operators for controlling a respective vehicle and at least one of the plurality of human interface devices is configured to only display the information to a passive user from the network of human operators.

27.-32. (canceled)
